(19) United States
(12) Patent Application Publication
(10) Pub. No.: US 2024/0147473 A1
(43) Pub. Date: May 2, 2024

(54) TECHNIQUES FOR MULTI-CELL SCHEDULING

(71) Applicant: QUALCOMM Incorporated, San Diego, CA (US)

(72) Inventors: Toru UCHINO, Zushi-shi (JP); Kazuki TAKEDA, Minato-ku (JP); Linhai HE, San Diego, CA (US); Masato KITAZOE, Hachiouji-shi (JP)

(21) Appl. No.: 18/479,350

(22) Filed: Oct. 2, 2023

Related U.S. Application Data
(60) Provisional application No. 63/381,252, filed on Oct. 27, 2022.

(51) Int. Cl. H04W 72/1273; H04W 72/232; H04W 76/20

(52) U.S. Cl. CPC H04W 72/1273; H04W 72/232; H04W 76/20

(57) ABSTRACT

Methods, systems, and devices for wireless communications are described. A user equipment (UE) may be configured to receive, from a network entity, a control message indicating a serving cell group including a set of serving cells usable for wireless communications at the UE. The UE may determine whether to monitor for a multi-cell scheduling message for the serving cell group based on activation states of the set of serving cells of the serving cell group, where the multi-cell scheduling message includes scheduling information for multiple serving cells of the set of serving cells. The UE may then monitor at least a portion of control signaling that includes the multi-cell scheduling message in accordance with the determination.

### CROSS REFERENCE

The present application for patent claims the benefit of U.S. Provisional Patent Application No. 63/381,252 by UCHINO et al., entitled “TECHNIQUES FOR MULTI-CELL SCHEDULING,” filed Oct. 27, 2022, assigned to the assignee hereof, and expressly incorporated by reference herein.

### FIELD OF TECHNOLOGY

The following relates to wireless communications, including techniques for multi-cell scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, wireless devices may be able to communicate with the network via one or more serving cells, such as a primary cell (PCell) and a secondary cell (SCell). When scheduling communications via serving cells, the network may utilize different scheduling schemes, including self-scheduling (e.g., a physical downlink control channel (PDCCH) message on Cell 1 schedules communications on Cell 1), cross-carrier scheduling (e.g., a PDCCH message on Cell 1 schedules communications on Cell 2), and multi-cell scheduling (e.g., a PDCCH message on Cell 1 schedules communications on Cells 1, 2, and 3).

### SUMMARY

The described techniques relate to improved methods, systems, devices, and apparatuses that support techniques for multi-cell scheduling. Generally, the aspects of the present disclosure provide signaling and configurations which address several ambiguities associated with multi-cell scheduling. In particular, aspects of the present disclosure are directed to sets of conditions, rules, and/or configurations which are used to determine whether a user equipment (UE) is expected to monitor for multi-cell scheduling information, and whether the UE is expected to restart activation timers for serving cells associated with multi-cell scheduling. For example, in accordance with a first implementation or rule, a UE may monitor for physical downlink control channel (PDCCH) including multi-cell scheduling information if at least one serving cell of a serving cell group is activated. In other cases, the UE may monitor for PDCCH including multi-cell scheduling information only if every serving cell of the serving cell group is activated. Upon receiving a PDCCH including multi-cell scheduling information, the UE may restart activation timers for each cell of the serving sell group in accordance with some implementations, or may restart activation timers only for those cells that actually included a resource allocation in accordance with some implementations.

A method is described. The method may include receiving, from a network entity, a control message indicating a serving cell group including a set of multiple serving cells usable for wireless communications at the UE, determining whether to monitor for a multi-cell scheduling message based on activation states of the set of multiple serving cells of the serving cell group, where the multi-cell scheduling message includes scheduling information for multiple serving cells of the set of multiple serving cells, and monitoring, in accordance with the determination, at least a portion of control signaling that includes the multi-cell scheduling message.

An apparatus is described. The apparatus may include a processor, memory coupled with the processor, and instructions stored in the memory. The instructions may be executable by the processor to cause the apparatus to receive, from a network entity, a control message indicating a serving cell group including a set of multiple serving cells usable for wireless communications at the UE, determine whether to monitor for a multi-cell scheduling message based on activation states of the set of multiple serving cells of the serving cell group, where the multi-cell scheduling message includes scheduling information for multiple serving cells of the set of multiple serving cells, and monitor, in accordance with the determination, at least a portion of control signaling that includes the multi-cell scheduling message.

Another apparatus is described. The apparatus may include means for receiving, from a network entity, a control message indicating a serving cell group including a set of multiple serving cells usable for wireless communications at the UE, means for determining whether to monitor for a multi-cell scheduling message based on activation states of the set of multiple serving cells of the serving cell group, where the multi-cell scheduling message includes scheduling information for multiple serving cells of the set of multiple serving cells, and means for monitoring, in accordance with the determination, at least a portion of control signaling that includes the multi-cell scheduling message.

A non-transitory computer-readable medium storing code is described. The code may include instructions executable by a processor to receive, from a network entity, a control message indicating a serving cell group including a set of multiple serving cells usable for wireless communications at the UE, determine whether to monitor for a multi-cell scheduling message based on activation states of the set of multiple serving cells of the serving cell group, where the multi-cell scheduling message includes scheduling information for multiple serving cells of the set of multiple serving cells, and monitor, in accordance with the determination, at least a portion of control signaling that includes the multi-cell scheduling message.

In some examples of the method, apparatuses, and non-transitory computer-readable medium described herein, determining whether to monitor for the multi-cell scheduling message may include operations, features, means, or instructions for determining to monitor for the multi-cell scheduling message based on each of the set of multiple serving cells of the serving cell group being in an active operational state at the UE.

In some examples of the method, apparatuses, and non-transitory computer-readable medium described herein, determining whether to monitor for the multi-cell scheduling message may include operations, features, means, or instructions for determining to monitor for the multi-cell scheduling message based on at least one serving cell of the set of multiple serving cells of the serving cell group being in an active operational state at the UE.

Some examples of the method, apparatuses, and non-transitory computer-readable medium described herein may further include operations, features, means, or instructions for determining a set of multiple activation states associated with the set of multiple serving cells of the serving cell group and determining a control message format associated with the multi-cell scheduling message based on the set of multiple activation states, where monitoring at least the portion of the control signaling includes monitoring for the control message format associated with the multi-cell scheduling message.

Some examples of the method, apparatuses, and non-transitory computer-readable medium described herein may further include operations, features, means, or instructions for receiving, from the network entity, a multi-cell scheduling configuration including one or more conditions associated with monitoring for the multi-cell scheduling message based on activation states of the set of multiple serving cells of the serving cell group, where the monitoring may be performed based on a satisfaction of the one or more conditions of the multi-cell scheduling configuration.

Some examples of the method, apparatuses, and non-transitory computer-readable medium described herein may further include operations, features, means, or instructions for receiving, from the network entity, a message indicating a deactivation of at least one serving cell of the serving cell group and deactivating each of the set of multiple serving cells of the serving cell group based on the message.

Some examples of the method, apparatuses, and non-transitory computer-readable medium described herein may further include operations, features, means, or instructions for refraining from monitoring for an additional multi-cell scheduling message for the serving cell group throughout a second time interval subsequent to the first time interval and monitoring the control signaling throughout the second time interval for a self-scheduling message associated with one or more serving cells of the serving cell group, a cross-carrier scheduling message associated with one or more serving cells of the serving cell group, or both.

Some examples of the method, apparatuses, and non-transitory computer-readable medium described herein may further include operations, features, means, or instructions for restarting a set of multiple timers associated with activation states of the set of multiple serving cells of the serving cell group based on receiving the multi-cell scheduling message.

Some examples of the method, apparatuses, and non-transitory computer-readable medium described herein may further include operations, features, means, or instructions for receiving, via the multi-cell scheduling message, a first indication of a first quantity of resource blocks (RBs) allocated for communications with the UE via the first serving cell, and a second indication of a second quantity of RBs allocated for communications with the UE via the second serving cell, restarting a first timer associated with a first activation state of the first serving cell based on the first quantity of RBs satisfying a threshold quantity, and refraining from restarting a second timer associated with a second activation state of the second serving cell based on the second quantity of RBs failing to satisfy the threshold quantity.

Some examples of the method, apparatuses, and non-transitory computer-readable medium described herein may further include operations, features, means, or instructions for identifying an expiration of the second timer associated with the second serving cell based on refraining from restarting the second timer and deactivating the second serving cell based on the expiration of the second timer.

Some examples of the method, apparatuses, and non-transitory computer-readable medium described herein may further include operations, features, means, or instructions for deactivating the first serving cell of the serving cell group based on deactivating the second serving cell.

Some examples of the method, apparatuses, and non-transitory computer-readable medium described herein may further include operations, features, means, or instructions for receiving, from the network entity, a multi-cell scheduling configuration including one or more conditions for restarting activation timers associated with the set of multiple serving cells of the serving cell group and restarting one or more activation timers associated with one or more serving cells of the serving cell group based on a satisfaction of the one or more conditions of the multi-cell scheduling configuration.

Some examples of the method, apparatuses, and non-transitory computer-readable medium described herein may further include operations, features, means, or instructions for receiving, via the multi-cell scheduling message, an indication of a set of RBs allocated for communications with the UE via the first serving cell and transmitting a feedback message to the network entity based on the first serving cell being in the deactivated operational state and based on the set of RBs being allocated for communications via the first serving cell.

Some examples of the method, apparatuses, and non-transitory computer-readable medium described herein may further include operations, features, means, or instructions for receiving, via the multi-cell scheduling message, an indication of a set of RBs allocated for communications with the UE via the first serving cell and transmitting a message to the network entity indicating a mis-match associated with operational states of the first serving cell at the UE and the network entity, the message including a cell identifier associated with the first serving cell and an indication of the deactivated operational state of the first serving cell at the UE.

In some examples of the method, apparatuses, and non-transitory computer-readable medium described herein, the message includes an uplink control information (UCI) message, a random access channel (RACH) message, a medium access control-control element (MAC-CE) message, a radio resource control (RRC) message, or any combination thereof.

Some examples of the method, apparatuses, and non-transitory computer-readable medium described herein may further include operations, features, means, or instructions for receiving, via the multi-cell scheduling message, an indication of a set of RBs allocated for communications with the UE via the first serving cell and activating the first serving cell from the deactivated operational state to an activated operational state based on the first serving cell being in the deactivated operational state and based on the set of RBs being allocated for communications via the first serving cell.

Some examples of the method, apparatuses, and non-transitory computer-readable medium described herein may further include operations, features, means, or instructions for transmitting a status report message to the network entity based on activating the first serving cell and communicating with the network entity via the first serving cell based on the status report message.

A method is described. The method may include transmitting, to a UE, a control message indicating a serving cell group including a set of multiple serving cells usable for wireless communications at the UE, determining whether to transmit a multi-cell scheduling message based on activation states of the set of multiple serving cells of the serving cell group, where the multi-cell scheduling message includes scheduling information for multiple serving cells of the set of multiple serving cells, and transmitting, in accordance with the determination, control signaling that includes the multi-cell scheduling message.

An apparatus is described. The apparatus may include a processor, memory coupled with the processor, and instructions stored in the memory. The instructions may be executable by the processor to cause the apparatus to transmit, to a UE, a control message indicating a serving cell group including a set of multiple serving cells usable for wireless communications at the UE, determine whether to transmit a multi-cell scheduling message based on activation states of the set of multiple serving cells of the serving cell group, where the multi-cell scheduling message includes scheduling information for multiple serving cells of the set of multiple serving cells, and transmit, in accordance with the determination, control signaling that includes the multi-cell scheduling message.

Another apparatus is described. The apparatus may include means for transmitting, to a UE, a control message indicating a serving cell group including a set of multiple serving cells usable for wireless communications at the UE, means for determining whether to transmit a multi-cell scheduling message based on activation states of the set of multiple serving cells of the serving cell group, where the multi-cell scheduling message includes scheduling information for multiple serving cells of the set of multiple serving cells, and means for transmitting, in accordance with the determination, control signaling that includes the multi-cell scheduling message.

A non-transitory computer-readable medium storing code is described. The code may include instructions executable by a processor to transmit, to a UE, a control message indicating a serving cell group including a set of multiple serving cells usable for wireless communications at the UE, determine whether to transmit a multi-cell scheduling message based on activation states of the set of multiple serving cells of the serving cell group, where the multi-cell scheduling message includes scheduling information for multiple serving cells of the set of multiple serving cells, and transmit, in accordance with the determination, control signaling that includes the multi-cell scheduling message.

In some examples of the method, apparatuses, and non-transitory computer-readable medium described herein, determining whether to transmit the multi-cell scheduling message may include operations, features, means, or instructions for determining to transmit for the multi-cell scheduling message based on each of the set of multiple serving cells of the serving cell group being in an active operational state at the UE.

In some examples of the method, apparatuses, and non-transitory computer-readable medium described herein, determining whether to transmit the multi-cell scheduling message may include operations, features, means, or instructions for determining to transmit for the multi-cell scheduling message based on at least one serving cell of the set of multiple serving cells of the serving cell group being in an active operational state at the UE.

Some examples of the method, apparatuses, and non-transitory computer-readable medium described herein may further include operations, features, means, or instructions for determining a set of multiple activation states associated with the set of multiple serving cells of the serving cell group and determining a control message format associated with the multi-cell scheduling message based on the set of multiple activation states, where the multi-cell scheduling message may be associated with the control message format.

Some examples of the method, apparatuses, and non-transitory computer-readable medium described herein may further include operations, features, means, or instructions for transmitting, to the UE, a multi-cell scheduling configuration including one or more conditions associated with the multi-cell scheduling message based on activation states of the set of multiple serving cells of the serving cell group, where transmitting the multi-cell scheduling message may be based on a satisfaction of the one or more conditions of the multi-cell scheduling configuration.

Some examples of the method, apparatuses, and non-transitory computer-readable medium described herein may further include operations, features, means, or instructions for transmitting, to the UE, a message indicating a deactivation of at least one serving cell of the serving cell group and deactivating each of the set of multiple serving cells of the serving cell group based on the message.

Some examples of the method, apparatuses, and non-transitory computer-readable medium described herein may further include operations, features, means, or instructions for refraining from transmitting for an additional multi-cell scheduling message for the serving cell group throughout a second time interval subsequent to the first time interval and transmitting the control signaling throughout the second time interval for a self-scheduling message associated with one or more serving cells of the serving cell group, a cross-carrier scheduling message associated with one or more serving cells of the serving cell group, or both.

Some examples of the method, apparatuses, and non-transitory computer-readable medium described herein may further include operations, features, means, or instructions for restarting a set of multiple timers associated with activation states of the set of multiple serving cells of the serving cell group based on transmitting the multi-cell scheduling message.

Some examples of the method, apparatuses, and non-transitory computer-readable medium described herein may further include operations, features, means, or instructions for transmitting, via the multi-cell scheduling message, a first indication of a first quantity of RBs allocated for communications with the UE via the first serving cell, and a second indication of a second quantity of RBs allocated for communications with the UE via the second serving cell, restarting a first timer associated with a first activation state of the first serving cell based on the first quantity of RBs satisfying a threshold quantity, and refraining from restarting a second timer associated with a second activation state of the second serving cell based on the second quantity of RBs failing to satisfy the threshold quantity.

Some examples of the method, apparatuses, and non-transitory computer-readable medium described herein may further include operations, features, means, or instructions for identifying an expiration of the second timer associated with the second serving cell based on refraining from restarting the second timer and deactivating the second serving cell based on the expiration of the second timer.

Some examples of the method, apparatuses, and non-transitory computer-readable medium described herein may further include operations, features, means, or instructions for deactivating the first serving cell of the serving cell group based on deactivating the second serving cell.

Some examples of the method, apparatuses, and non-transitory computer-readable medium described herein may further include operations, features, means, or instructions for transmitting, to the UE, a multi-cell scheduling configuration including one or more conditions for restarting activation timers associated with the set of multiple serving cells of the serving cell group and restarting one or more activation timers associated with one or more serving cells of the serving cell group based on a satisfaction of the one or more conditions of the multi-cell scheduling configuration.

Some examples of the method, apparatuses, and non-transitory computer-readable medium described herein may further include operations, features, means, or instructions for transmitting, via the multi-cell scheduling message, an indication of a set of RBs allocated for communications with the UE via the first serving cell and receiving a feedback message from the UE based on the first serving cell being in the deactivated operational state at the UE and based on the set of RBs being allocated for communications via the first serving cell.

Some examples of the method, apparatuses, and non-transitory computer-readable medium described herein may further include operations, features, means, or instructions for transmitting, via the multi-cell scheduling message, an indication of a set of RBs allocated for communications with the UE via the first serving cell and receiving a message from the UE indicating a mis-match associated with operational states of the first serving cell at the UE and the network entity, the message including a cell identifier associated with the first serving cell and an indication that the first serving cell may be in a deactivated operational state at the UE.

In some examples of the method, apparatuses, and non-transitory computer-readable medium described herein, the message includes a UCI message, a RACH message, a MAC-CE message, an RRC message, or any combination thereof.

Some examples of the method, apparatuses, and non-transitory computer-readable medium described herein may further include operations, features, means, or instructions for receiving a status report message from the UE based on the multi-cell scheduling message and communicating with the UE via a serving cell of the serving cell group based on the status report message.

### BRIEF DESCRIPTION OF THE DRAWINGS

FIG. 1 illustrates an example of a wireless communications system that supports techniques for multi-cell scheduling in accordance with one or more aspects of the present disclosure.

FIG. 2 illustrates an example of a wireless communications system that supports techniques for multi-cell scheduling in accordance with one or more aspects of the present disclosure.

FIG. 3 illustrates an example of a resource configuration that supports techniques for multi-cell scheduling in accordance with one or more aspects of the present disclosure.

FIG. 4 illustrates an example of a resource configuration that supports techniques for multi-cell scheduling in accordance with one or more aspects of the present disclosure.

FIG. 5 illustrates an example of a resource configuration that supports techniques for multi-cell scheduling in accordance with one or more aspects of the present disclosure.

FIG. 6 illustrates an example of a resource configuration that supports techniques for multi-cell scheduling in accordance with one or more aspects of the present disclosure.

FIG. 7 illustrates an example of a process flow that supports techniques for multi-cell scheduling in accordance with one or more aspects of the present disclosure.

FIGS. 8 and 9 illustrate block diagrams of devices that support techniques for multi-cell scheduling in accordance with one or more aspects of the present disclosure.

FIG. 10 illustrates a block diagram of a communications manager that supports techniques for multi-cell scheduling in accordance with one or more aspects of the present disclosure.

FIG. 11 illustrates a diagram of a system including a device that supports techniques for multi-cell scheduling in accordance with one or more aspects of the present disclosure.

FIGS. 12 and 13 illustrate block diagrams of devices that support techniques for multi-cell scheduling in accordance with one or more aspects of the present disclosure.

FIG. 14 illustrates a block diagram of a communications manager that supports techniques for multi-cell scheduling in accordance with one or more aspects of the present disclosure.

FIG. 15 illustrates a diagram of a system including a device that supports techniques for multi-cell scheduling in accordance with one or more aspects of the present disclosure.

FIGS. 16 through 20 illustrate flowcharts showing methods that support techniques for multi-cell scheduling in accordance with one or more aspects of the present disclosure.

### DETAILED DESCRIPTION

In some wireless communication systems, wireless devices may be able to communicate with the network via one or more serving cells, such as a primary cell (PCell) and a secondary cell (SCell). When scheduling communications via serving cells, the network may utilize different scheduling schemes, including self-scheduling (e.g., a physical downlink control channel (PDCCH) message on Cell 1 schedules communications on Cell 1), cross-carrier scheduling (e.g., a PDCCH message on Cell 1 schedules communications on Cell 2), and the like.

Moreover, in some cases, the network may utilize multi-cell scheduling, in which a PDCCH message on one cell schedules communications on multiple cells within a serving cell group (e.g., PDCCH message on Cell 1 schedules communications on Cells 1, 2, and 3). However, multi-cell scheduling may result in several ambiguities at the user equipment (UE). For example, if some cells of the serving cell group are activated, but others are deactivated, it may be unclear whether the UE is expected to monitor multi-cell scheduling messages for the serving cell group. Moreover, if a multi-cell scheduling message allocates resources for some cells of a serving cell group, but not for other cells, it may be unclear whether activation timers for the cells of the serving cell group are to be restarted or not.

Accordingly, aspects of the present disclosure are directed to signaling and configurations that address some of the ambiguities associated with for multi-cell scheduling techniques. In particular, aspects of the present disclosure are directed to sets of conditions, rules, and/or configurations which are used to determine whether a UE is expected to monitor for multi-cell scheduling information, and whether the UE is expected to restart activation timers for serving cells associated with multi-cell scheduling.

For example, in accordance with a first implementation or rule, a UE may monitor for PDCCH including multi-cell scheduling information if at least one serving cell of a serving cell group is activated. In other cases, in accordance with a second implementation or rule, the UE may monitor for PDCCH including multi-cell scheduling information only if every serving cell of the serving cell group is activated. In yet other cases, and in accordance with a third implementation or rule, the UE may monitor for PDCCH including multi-cell scheduling information which exhibits a DCI format that corresponds to the number of activated serving cells in the serving cell group.

Upon receiving a multi-cell scheduling message for the serving cell group, the UE may restart activation timers for each cell of the serving sell group, or may restart activation timers only for those cells that actually included a resource allocation. In some aspects, by monitoring for multi-cell scheduling messages, the UE may be able to determine whether there is any mismatch between the perception of an activation state of a serving cell at the UE and the network (e.g., UE perceives a serving cell in a deactivated state and the network perceives the serving cell in an activated state, or vice versa). Thus, techniques described herein may enable the UE to identify mismatches of activation states between the UE and the network, and signal the identified mismatches to the network to resolve the mismatches.

Aspects of the disclosure are initially described in the context of wireless communications systems. Additional aspects of the disclosure are described in the context of example resource configurations and an example process flow. Aspects of the disclosure are further illustrated by and described with reference to apparatus diagrams, system diagrams, and flowcharts that relate to techniques for multi-cell scheduling.

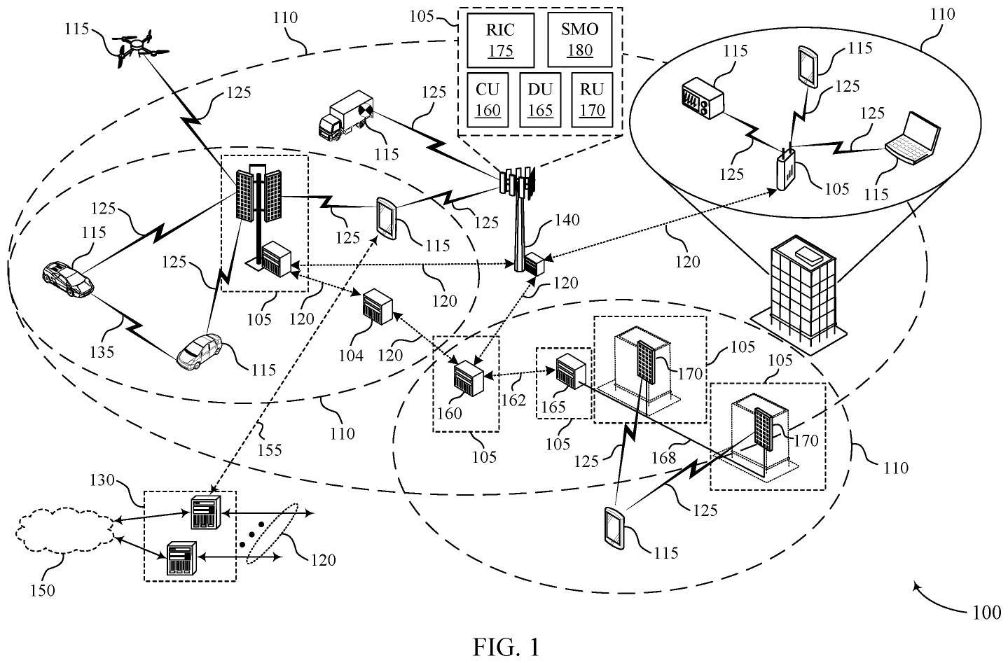

FIG. 1 illustrates an example of a wireless communications system 100 that supports techniques for multi-cell scheduling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for multi-cell scheduling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, wireless devices (e.g., UEs 115, network entities 105, IAB nodes, etc.) of the wireless communications system 100 may be configured to support signaling and configurations that address some of the ambiguities associated with multi-cell scheduling techniques. In particular, the wireless communications system 100 may support sets of conditions, rules, and/or configurations which are used to determine whether a UE 115 (or other wireless device) is expected to monitor for multi-cell scheduling information, and whether the UE 115 is expected to restart activation timers for serving cells associated with multi-cell scheduling.

For example, in accordance with a first implementation or rule, a UE 115 of the wireless communications system 100 may monitor for multi-cell scheduling messages from the network if at least one serving cell of a serving cell group is activated. In other cases, in accordance with a second implementation or rule, the UE 115 may monitor for PDCCH including multi-cell scheduling information only if every serving cell of the serving cell group is activated. In yet other cases, and in accordance with a third implementation or rule, the UE 115 may monitor for PDCCH including multi-cell scheduling information which exhibits a downlink control information (DCI) format that corresponds to the number (e.g., quantity) of activated serving cells in the serving cell group.

Upon receiving a multi-cell scheduling message for the serving cell group, the UE 115 may restart activation timers for each cell of the serving sell group, or may restart activation timers only for those cells that actually included a resource allocation. In some aspects, by monitoring for multi-cell scheduling messages, the UE 115 may be able to determine whether there is any mismatch between the perception of an activation state of a serving cell at the UE 115 and the network (e.g., UE 115 perceives a serving cell in a deactivated state and the network entity 105 perceives the serving cell in an activated state, or vice versa). Thus, techniques described herein may enable the UE 115 to identify mismatches of activation states between the UE 115 and the network, and signal the identified mismatches to the network to resolve the mismatches.

Techniques described herein may resolve ambiguities associated with multi-cell scheduling techniques, which may enable more efficient and reliable use of multi-cell scheduling. In particular, techniques described herein may enable UEs 115 to determine whether or not to monitor for multi-cell scheduling messages, which may reduce a quantity of retransmissions for multi-cell scheduling, thereby improving resource utilization and reducing power consumption at the respective devices. Moreover, techniques described herein may enable UEs 115 to determine when to restart activation timers for serving cells upon receiving a multi-cell scheduling message, which may improve coordination between the UEs 115 and the network and reduce mis-matches between perceived activation states of serving cells at the UEs 115 and the network, which may improve an efficiency and reliability of wireless communications via the respective serving cells.

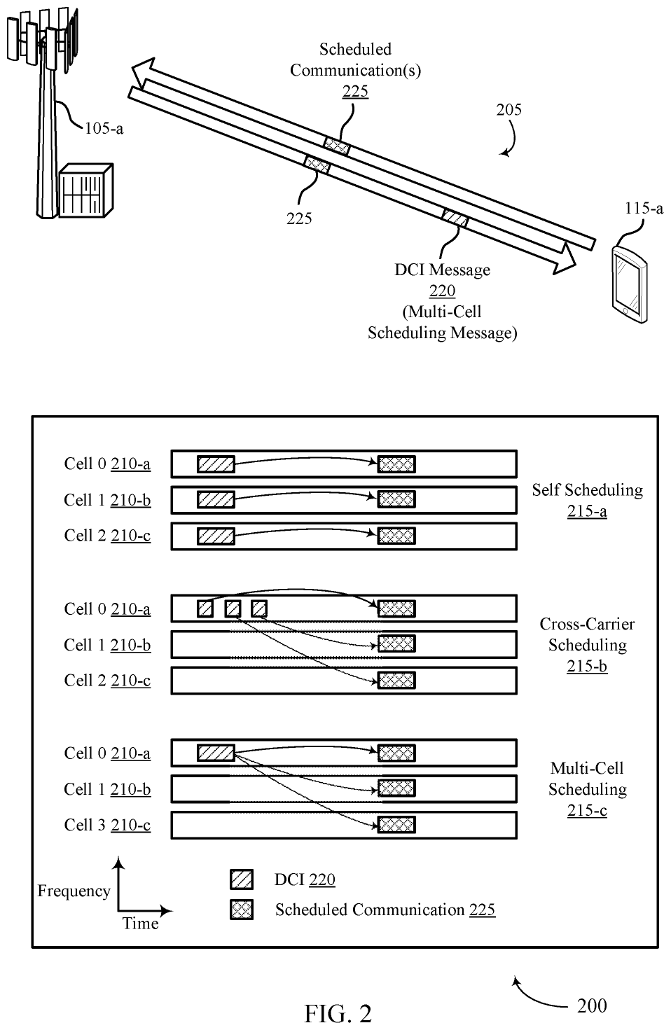

FIG. 2 illustrates an example of a wireless communications system 200 that supports techniques for multi-cell scheduling in accordance with one or more aspects of the present disclosure. Aspects of the wireless communications system 200 may implement, or be implemented by, aspects of wireless communications system 100. For example, wireless communications system 200 may support techniques for multi-cell scheduling, as described in FIG. 1.

The wireless communications system 200 may include a UE 115-a and a network entity 105-a, which may be examples of UEs 115 and network entities 105 as described with reference to FIG. 1. The UE 115-a may communicate with the network entity 105-a using a communication link 205, which may be an example of an NR or LTE link between the UE 115-a and the network entity 105-a. In some cases, the communication link 205 between the UE 115-a and the network entity 105-a may include an example of an access link (e.g., Uu link) which may include a bi-directional link that enables both uplink and downlink communication. For example, the UE 115-a may transmit uplink signals, such as uplink control signals or uplink data signals, to the network entity 105-a using the communication link 205 and the network entity 105-a may transmit downlink signals, such as downlink control signals or downlink data signals, to the UE 115-a using the communication link 205.

As noted previously herein, in some implementations, the UE 115-a may be configured to communicate with the network (e.g., network entity 105, other network entities 105) via one or more component carriers or serving cells, such as a PCell and an SCell. For example, as shown in FIG. 2, the UE 115-a may be configured to communicate with the network via a first serving cell 210-a (Cell 0, or first component carrier), a second serving cell 210-b (Cell 1, or second component carrier), and a third serving cell 210-c (Cell 2, or third component carrier). In this example, the serving cells 210-a, 210-b, 210-c may be associated with (e.g., supported by) the network entity 105-a. Additionally, or alternatively, the serving cells 210-a, 210-b, 210-c may be associated with (e.g., supported by) multiple network entities 105.

When scheduling communications via serving cells 210, the network (e.g., network entity 105-a) may utilize different scheduling schemes, including self-scheduling, cross-carrier scheduling, and multi-cell scheduling. For example, in the context of a self-scheduling configuration 215-a, PDCCH messages (e.g., DCI messages 220) received at the UE 115-a via each respective serving cell 210 may be used to schedule communications 225 on the corresponding serving cell 210. For instance, a first DCI message 220 received via the first serving cell 210-a may be used to schedule a first communication 225 on the first serving cell 210-a, and a second DCI message 220 received via the second serving cell 210-b may be used to schedule a second communication 225 on the second serving cell 210-b.

Comparatively, in the context of a cross-carrier scheduling configuration 215-b, PDCCH messages (e.g., DCI messages 220) received via one serving cell 210/component carrier may be used to schedule communications on other serving cells 210/component carriers. For example, as shown in FIG. 2, individual DCI messages 220 received at the UE 115-a via the first serving cell 210-a may be used to schedule communications 225 on the first serving cell 210-a, the second serving cell 210-b, and/or the third serving cell 210-c.

Moreover, in the context of a multi-cell scheduling configuration 215-c (which may sometimes be referred to as multi-carrier enhancement (MCE)), a single PDCCH message (e.g., DCI message 220) may carry scheduling information for multiple serving cells 210 in a serving cell group (e.g., carrier aggregation). In other words, a single DCI message 220 may schedule communications 225 within multiple serving cells 210 of a serving cell group. For example, as shown in the multi-cell scheduling configuration 215-c illustrated in FIG. 2, a single DCI message 220 received by the UE 115-a via the first serving cell 210-a may schedule communications 225 in each of the first serving cell 210-a, the second serving cell 210-b, and the third serving cell 210-c.

In the context of the multi-cell scheduling configuration 215-c, the scheduled serving cells 210 (e.g., serving cells 210-a, 210-b, 210-c) may be associated with the scheduling serving cell 210 (e.g., first serving cell 210-a), and/or associated with resources for the PDCCH (e.g., scheduling information) reception. In some implementations, MAC specifications may define UE 115-a behavior in carrier aggregation (e.g., multi-cell scheduling configuration 215-c) on a per-serving cell 210 basis. Moreover, for dynamic scheduling, the UE 115-a may be expected to use multiple DCI messages 220 for multiple scheduling cells.

Multi-cell scheduling techniques may enable increased scheduling flexibility and spectral/power efficiency when scheduling the UE 115-a to perform communications over multiple serving cells 210, including intra-band and inter-band cells. In particular, as wireless communications systems support more available scattered spectrum bands and/or wider bandwidth spectrum, the ability to perform simultaneous scheduling via the multi-cell scheduling configuration 215-c may continue to increase. Moreover, the ability to schedule communications within multiple serving cells 210 via a single DCI message 220 may reduce control signaling overhead, and improve resource utilization within the wireless communications system 200.

However, multi-cell scheduling may result in several ambiguities at the UE 115-a, including: (1) PDCCH monitoring in deactivated cells, (2) MAC-related timer handling, and (3) activation state mismatch detection and handling. Each of these ambiguities/problems with conventional multi-carrier scheduling techniques will be described in turn.

As for PDCCH monitoring, the UE 115-a may be expected to monitor for PDCCH in a serving cell 210 when the respective serving cell 210 is activated. Conversely, when a serving cell 210 is deactivated (or in a dormant state), the UE 115-a is not expected to monitor for PDCCH in the serving cell 210. Such behavior may be defined in MAC-related specifications. In case of a multi-cell scheduling configuration 215-c (e.g., case where one DCI message 220 carries scheduling information for multiple serving cells 210), there could be a case where some serving cells 210 in the serving cell group are activated, and other serving cells 210 in the serving cell group are deactivated (or in a dormant state). In such cases, it may be unclear whether the UE 115-a is expected to monitor for DCI messages 220 including multi-cell scheduling information for the serving cell group. In other words, there is ambiguity as to whether the UE 115-a is expected to monitor the PDCCH for the multi-cell scheduling messages (e.g., whether the PDCCH should be monitored from the activated cell perspective, but should not be monitored from the deactivated cell perspective).

Accordingly, some aspects of the present disclosure are directed to rules, configurations, and/or conditions usable by the UE 115-a and the network entity 105-b to determine whether or not the UE 115-a is expected to monitor for multi-cell scheduling messages, and whether the network entity 105 is able to transmit multi-cell scheduling messages.

For example, in accordance with some implementations, the UE 115-a may be expected to monitor for multi-cell scheduling messages (e.g., DCI messages 220) when any serving cell 210 of a serving cell group is in an activated state. Comparatively, on other implementations, the UE 115-a may be expected to monitor for multi-cell scheduling messages (e.g., DCI messages 220) only when every serving cell 210 of a serving cell group is in an activated state. In additional or alternative implementations, the UE 115-a may monitor for multi-cell scheduling messages which exhibit a DCI format that corresponds to the number/quantity of activated serving cells 210 in the serving cell group. In this regard, techniques described herein may help resolve ambiguities associated with the multi-cell scheduling configuration 215-c in the context of PDCCH monitoring.

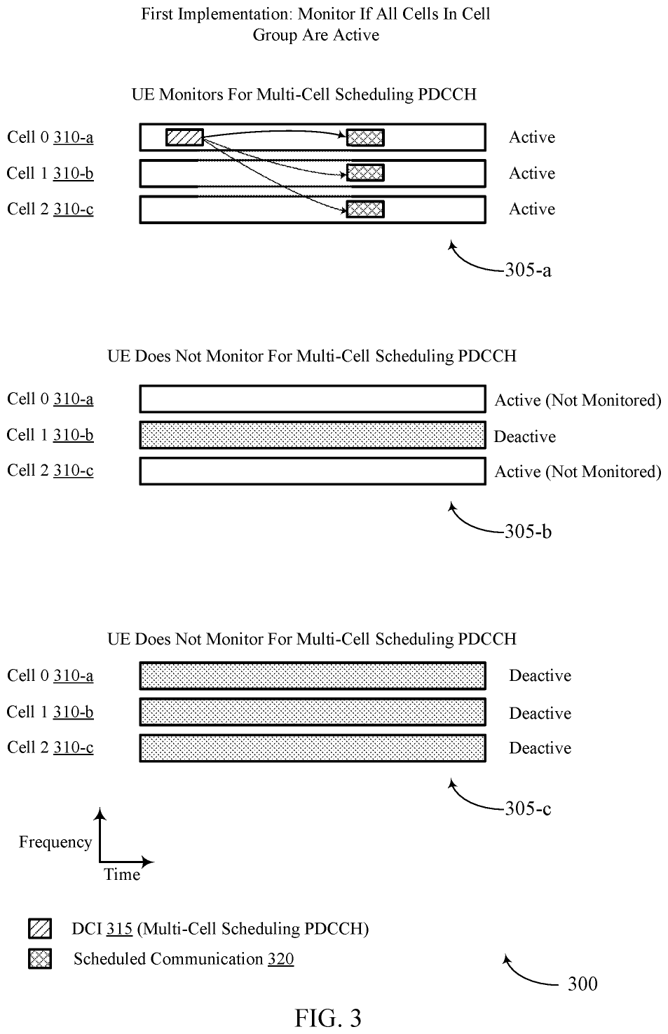

Rules and conditions for multi-cell scheduling configurations used to resolve PDCCH monitoring ambiguities will be further shown and described in the context of FIGS. 3-5.

Additionally, for MAC-related timer handling, there are several timers to manage activation states of serving cells 210 or BWPs at the UE 115-a, including an SCell activation/deactivation timer (e.g., SCellDeactivationTimer), a BWP timer (e.g., BWP-InactivityTimer, in case of bandwidth adaptation), and a DRX timer (e.g., drx-InactivityTimer, in cases where multiple DRX groups are used). In some aspects, these timers may be used to keep the serving cell(s) 210 active (e.g., in an activated state) so that the UE 115-a and the network entity 105-a may communicate via the serving cells 210. Moreover, the timers may be restarted at the UE 115-a and/or network entity 105-a when PDCCH messages (e.g., DCI messages 220) schedule subsequent communications 225 on the respective serving cells 210 (e.g., timers restarted upon downlink assignment and/or uplink grant).

In the context of the self-scheduling configuration 215-a and the cross-carrier scheduling configuration 215-b, there is no issue activating and restarting timers, as any PDCCH reception for a serving cell is interpreted as a resource allocation for the respective serving cell 210, which is used to restart the respective timers. However, in the context of the multi-cell scheduling configuration 215-c, there may be a case where a DCI message 220 includes a resource allocation field(s) for each serving cell 210 in the serving cell group, but in which data is not actually allocated for one or more serving cells 210 in the group (e.g., the number of PRBs allocated for a given serving cell 210 is zero). For example, referring to the multi-cell scheduling configuration 215-c, the DCI message 220 may allocate resources for communications 225 on the first serving cell 210-a and the second serving cell 210-b (e.g., non-zero resource allocation fields), but may not allocate any resources for the third serving cell 210-c (e.g., resource allocation field set to zero). In this example, the behavior of the UE 115-a may be ambiguous. In particular, it may be unclear whether activation timers for the serving cells 210 of the serving cell group are to be restarted or not. Some UEs 115 may interpretate such a scenario as “resource allocation is indicated” for all the serving cells 210 in the group, and may therefore restart activation timers for all serving cells 210 in the group, whereas other UEs 115 may not make such an interpretation, resulting in ambiguity as to whether activation timers for each respective serving cell 210 within the serving cell group should be restarted or not.

Accordingly, some aspects of the present disclosure are directed to rules, configurations, and/or conditions usable by the UE 115-a and the network entity 105-b to determine whether or not to restart timers (e.g., activation timers) for serving cells 210 based on received multi-cell scheduling messages.

For example, in accordance with some implementations, upon receiving a multi-cell scheduling message (e.g., DCI message 220), the UE 115-a and/or the network entity 105-a may be configured to restart activation timers for every serving cell 210 in the serving cell group. Comparatively, on other implementations, the UE 115-a and/or the network entity 105-a may be configured to restart activation timers only for those every serving cells 210 for which the DCI message 220 included non-zero resource allocations. In this regard, techniques described herein may help resolve ambiguities associated with restarting timers for serving cells 210 in the context of PDCCH monitoring.

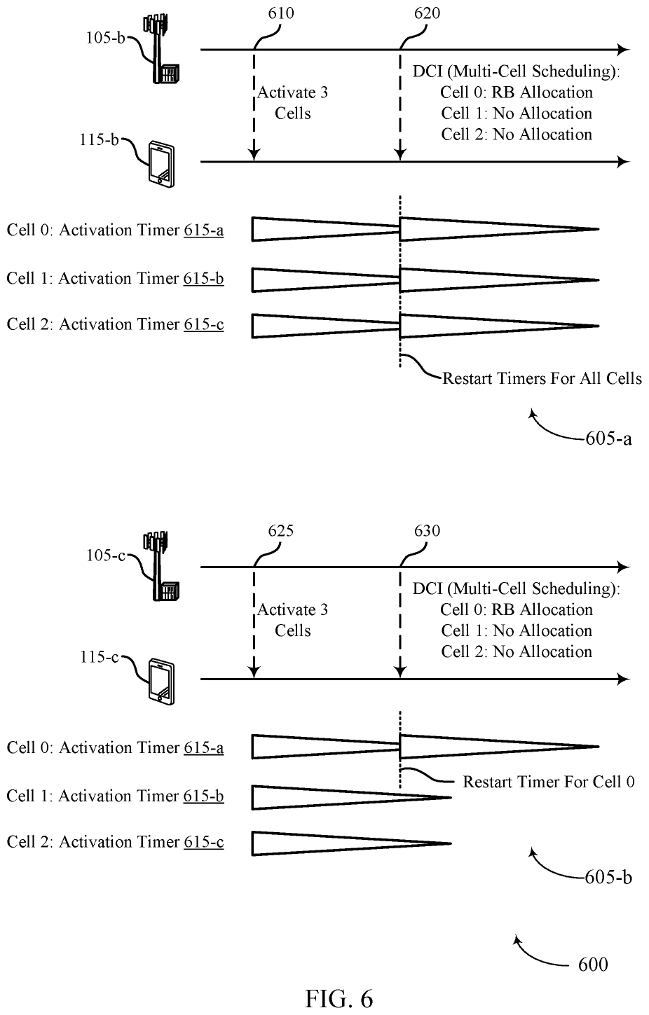

Rules and conditions for multi-cell scheduling configurations used to resolve ambiguities associated with serving cell 210 activation timers will be further shown and described in the context of FIG. 6.

Furthermore, as noted previously herein, some techniques for multi-cell scheduling may result in mismatches between perceived activation states of serving cells 210 at the UE 115-a and the network entity 105-a. In particular, in some conventional wireless communications systems, it may be left up to network implementation as to how the network detects and handles mismatches between SCell activation states mismatches between the network and the UE 115-a. A mismatch may occur when the UE 115 determines that a serving cell 210 is in a deactivated state but the network entity 105-a determines that the serving cell 210 is in an activated state, or vice versa.

In some cases, mismatches between perceived activation states of a serving cell 210 may occur when HARQ messages responsive to activation/deactivation messages (e.g., MAC-CE) are not successfully exchanged between devices (e.g., NACK-to-ACK false detection). Additionally, or alternatively, a timer value mismatch for a serving cell 210 may occur between the network and UE 115-a due to a missing PDCCH message, thereby resulting in a mismatch between perceived activation states.

Mismatches between perceived activation states may result in wasted communications resources, unnecessary power consumption, or both. For example, in cases where the network entity 105-a determines that a serving cell 210 is in an activated state, but the UE 115-a determines that the serving cell 210 is in a deactivated state, the network entity 105-a may attempt to schedule communications on the serving cell 210 (which is perceived to be deactivated at the UE 115-a), thereby leading to data transmission delay and a waste of resources. Conversely, in cases where the network entity 105-a determines that a serving cell 210 is in a deactivated state, but the UE 115-a determines that the serving cell 210 is in an activated state, the UE 115-a may continue to monitor for scheduling information for the serving cell 210, resulting in unnecessary power consumption.

According to conventional techniques, mismatches between perceived activation states may not be detected by the UE 115-a, and it is left up to network implementation to detect and handle the mismatch (e.g., by observing CQI values, HARQ error rates, etc.). In such cases, the network entity 105-a may be expected to detect such mismatches (e.g., implicitly), which may delay identification of the mismatch. Additionally, the network entity 105-a may be subject to several restrictions which restrict the ability of the network entity 105-a to identify and handle mismatches between perceived activation states. For example, the network entity 105-a may be expected to configure CQI resources for all SCells (e.g., serving cells 210) even in cases where the SCells have similar radio characteristics, which may consume uplink resources of SPCells (or PUCCH SCells) unnecessarily.

Accordingly, some aspects of the present disclosure may enable UEs 115-a to detect and handle mismatches between perceived activation states of serving cells 210 within a serving cell group based on received multi-cell scheduling messages. For example, if a UE 115-a receives a DCI message 220 (e.g., multi-cell scheduling message) which allocated resources for a serving cell 210 which is perceived to be in a deactivated state at the UE 115-a, the UE 115-a may be configured to activate the serving cell 210, report the identified mismatch to the network entity 105-a, or both.

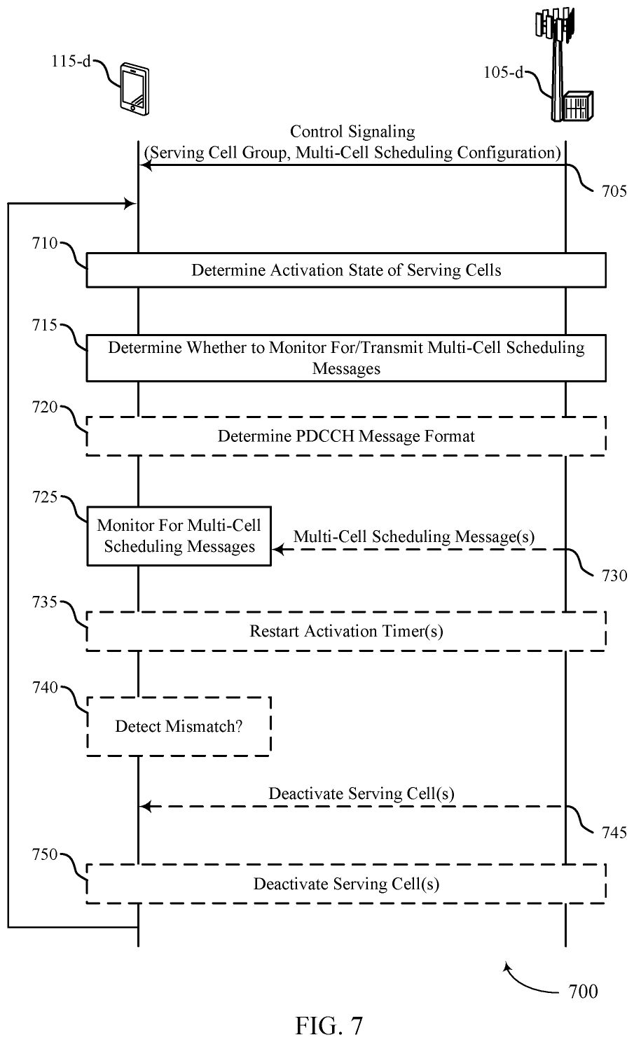

Aspects of the present disclosure that enable UEs 115-a to detect and resolve mismatches between perceived activation states of serving cells 210 will be further shown and described in the context of FIG. 7.

FIG. 3 illustrates an example of a resource configuration 300 that supports techniques for multi-cell scheduling in accordance with one or more aspects of the present disclosure. Aspects of the resource configuration 300 may implement, or be implemented by, the wireless communications system 100, the wireless communications system 200, or both.

The resource configuration 300 includes different monitoring configurations 305-a, 305-b, and 305-c which illustrate different examples for PDCCH monitoring in the context of multi-cell scheduling. Each monitoring configuration 305 illustrates a serving cell group which may be configured at a UE 115, where the serving cell group includes a first serving cell 310-a (Cell 0), a second serving cell 310-b (Cell 1), and a third serving cell 310-c (Cell 2). The serving cells 310-a, 310-b, and 310-c illustrated in FIG. 3 may be examples of the serving cells 210-a, 210-b, and 210-c illustrated in FIG. 2.

In particular, the resource configuration 300 illustrated in FIG. 3 illustrates a first implementation, a first rule, or a first condition that may be used by a UE 115 when determining whether or not the UE 115 is expected to monitor for multi-cell scheduling for a serving cell group. In accordance with the first implementation, the UE 115 may monitor for multi-cell scheduling messages only when all serving cells in a serving cell group are activated (e.g., in an activated state). In other words, the UE 115 may not monitor for multi-cell scheduling messages (e.g., DCI, PDCCH) if any serving cell 310 in the serving cell group is deactivated.

In some aspects, the UE 115 may be instructed (e.g., by a network entity 105) and/or preconfigured to monitor for multi-cell scheduling messages in accordance with the first implementation shown and described in FIG. 3. For example, in some cases, a network entity 105 may indicate a multi-cell scheduling configuration which includes a condition that the UE 115 is expected to monitor for multi-cell scheduling messages when every serving cell 310 of a serving cell group is activated (in accordance with the first implementation).

For instance, referring to the first monitoring configuration 305-a, each of the serving cells 310-a, 310-b, and 310-c may be in an activated state. As such, the UE 115 may be expected to monitor for DCI messages 315 (e.g., multi-cell scheduling messages) which schedule communications 320 within the respective serving cells 310 of the serving cell group in accordance with the first implementation. In other words, the condition for PDCCH monitoring may be satisfied due to all the serving cells 310 being in an activated state at the UE 115.

Comparatively, referring to the second monitoring configuration 305-b, the first serving cell 310-a and the third serving cell 310-c may be activated, where the second serving cell 310-b is deactivated. In this example, because the second serving cell 310-b is deactivated, the UE 115 may not monitor for multi-cell scheduling messages. In other words, the condition for PDCCH monitoring may not be satisfied due to at least one serving cell 310 being in a deactivated state at the UE 115.

In some implementations, even if a serving cell 310 is activated, the UE 115 may not monitor multi-cell scheduling messages for the serving cell 310 exceptionally. In such cases, the network may define a new state, or the UE 115 may switch to a BWP that does not include PDCCH resources for multi-cell scheduling messages.

Stated differently, even in cases where the UE 115 is not expected to monitor for multi-cell scheduling messages (as shown in the second monitoring configuration 305-b), the UE 115 may still monitor for other types of PDCCH, such as self-scheduling messages and/or cross-carrier scheduling messages. In this regard, the UE 115 may be configured to refrain from monitoring for PDCCH formats (e.g., DCI formats) associated with multi-cell scheduling, but may continue to monitor for PDCCH formats associated with self-scheduling and/or cross-carrier scheduling within/across the respective serving cells 310 of the serving cell group.

In some aspects, if any of the serving cells 310 in a serving cell group are deactivated, the remaining serving cells 310 in the serving cell group may also be deactivated (e.g., cell group basis deactivation). Such cell group basis deactivation may be performed by autonomous UE 115 behavior, configured by the network, or both.

In the context of autonomous UE 115 behavior, the UE 115 may be configured to apply activation/deactivation commands for all the serving cells 310 in the serving cell group.

For example, referring to the first monitoring configuration 305-a, the UE 115 may determine to deactivate the first serving cell 310-a of the serving cell group, such as based on an expiration of an activation timer for the first serving cell 310, based on explicit signaling from the network (e.g., MAC-CE deactivation command), or both. For instance, an activation timer (e.g., SCellDeactivationTimer) may be maintained or controlled either per serving cell 310 or per serving cell group. In this example, upon deactivating the first serving cell 310-a, the UE 115 may perform cell basis deactivation and deactivate the second serving cell 310-b and the third serving cell 310-c, thereby resulting in the third monitoring configuration 305-c.

Comparatively, in the case of network handling, a network entity 105 may be configured to handle cell group basis deactivation by transmitting appropriate commands such as MAC-CE or RRC configuration messages used to indicate a deactivation of all serving cells 310 in a serving cell group. In such cases, activations/deactivations of serving cells 310 may be aligned for the serving cells 310 in a MAC-CE and/or RRC message. Additionally, or alternatively, the network may perform cell group basis deactivation by setting an activation timer (e.g., SCelldeactivationTimer) for the serving cell group to infinity or another inapplicable value, disabling the timer, and the like. In such cases, if there is erroneous indication of an activation/deactivation for cell group basis deactivation (e.g., such misalignment of activation/deactivation indications), the UE 115 may be configured to ignore the activation/deactivation command, report the misalignment to the network, or both.

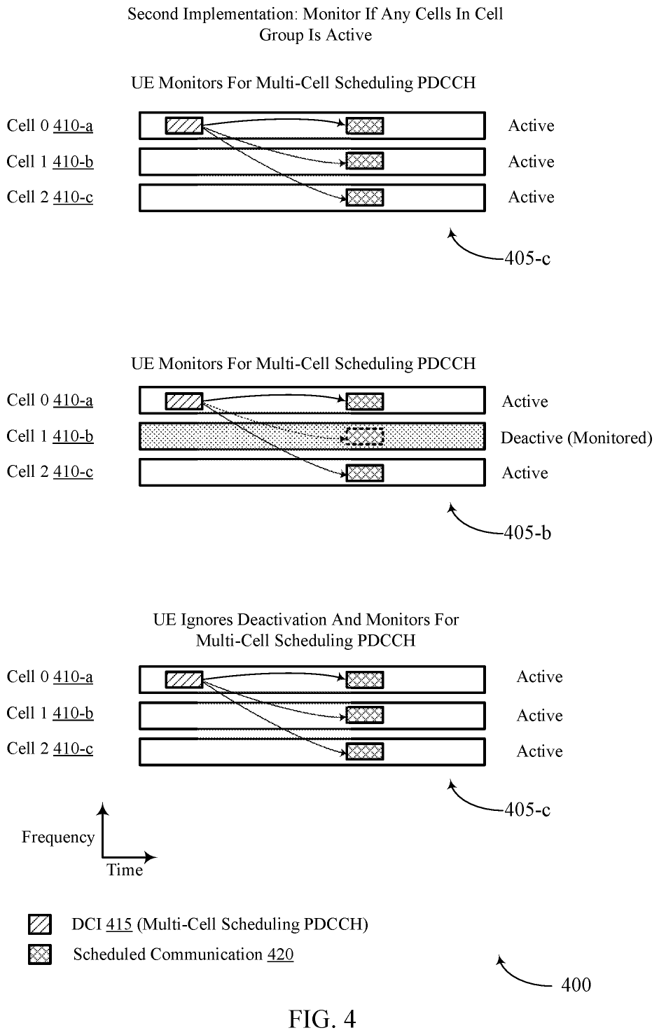

FIG. 4 illustrates an example of a resource configuration 400 that supports techniques for multi-cell scheduling in accordance with one or more aspects of the present disclosure. Aspects of the resource configuration 400 may implement, or be implemented by, the wireless communications system 100, the wireless communications system 200, the resource configuration 300, or any combination thereof.

The resource configuration 400 includes different monitoring configurations 405-a, 405-b, and 405-c which illustrate different examples for PDCCH monitoring in the context of multi-cell scheduling. Each monitoring configuration 405 illustrates a serving cell group which may be configured at a UE 115, where the serving cell group includes a first serving cell 410-a (Cell 0), a second serving cell 410-b (Cell 1), and a third serving cell 410-c (Cell 2). The serving cells 410-a, 410-b, and 410-c illustrated in FIG. 3 may be examples of the serving cells 210-a, 210-b, and 210-c illustrated in FIG. 2.

In particular, the resource configuration 400 illustrated in FIG. 4 illustrates a second implementation, a second rule, or a second condition that may be used by a UE 115 when determining whether or not the UE 115 is expected to monitor for multi-cell scheduling for a serving cell group. In accordance with the second implementation, the UE 115 may monitor for multi-cell scheduling messages when any serving cell in a serving cell group is activated (e.g., in an activated state).

In some aspects, the UE 115 may be instructed (e.g., by a network entity 105) and/or preconfigured to monitor for multi-cell scheduling messages in accordance with the second implementation shown and described in FIG. 4. For example, in some cases, a network entity 105 may indicate a multi-cell scheduling configuration which includes a condition that the UE 115 is expected to monitor for multi-cell scheduling messages when at least one serving cell 410 of a serving cell group is activated (in accordance with the second implementation). Moreover, in some cases, the UE 115 may be configured with a multi-cell scheduling configuration which instructs the UE 115 to monitor for multi-cell scheduling messages in accordance with the first implementation shown and described in FIG. 3 or the second implementation shown and described in FIG. 4.

For instance, referring to the first monitoring configuration 405-a, each of the serving cells 410-a, 410-b, and 410-c may be in an activated state. As such, the UE 115 may be expected to monitor for DCI messages 415 (e.g., multi-cell scheduling messages) which schedule communications 420 within the respective serving cells 410 of the serving cell group in accordance with the second implementation. In other words, the condition for PDCCH monitoring may be satisfied due to at least one serving cell 410 of the serving cell group being in an activated state at the UE 115.

Similarly, referring to the second monitoring configuration 405-b, the first serving cell 410-a and the third serving cell 410-c may be activated, where the second serving cell 410-b is deactivated. In this example, because at least one serving cell 410 is activated, the UE 115 may monitor for multi-cell scheduling messages (e.g., DCI message 415). This may be contrasted to the second monitoring configuration 305-b illustrated in FIG. 3, in which the UE 115 does not monitor for multi-cell scheduling messages.

In some implementations, even if a serving cell 410 is deactivated, the UE 115 may monitor multi-cell scheduling messages for the serving cell 410 exceptionally. In such cases, the network may define a new state, or the UE 115 may be configured to ignore or discard scheduling information for the deactivated serving cells 410.

As described with reference to FIG. 3, in some aspects, the UE 115 and/or the network may be configured to perform cell group basis deactivation and/or activation. In such cases, if any of the serving cells 410 in a serving cell group are deactivated, the remaining serving cells 410 in the serving cell group may also be deactivated (e.g., cell group basis deactivation). Similarly, if any of the serving cells 410 in a serving cell group are activated, the remaining serving cells 410 in the serving cell group may also be activated (e.g., cell group basis activation). Such cell group basis deactivation may be performed by autonomous UE 115 behavior, configured by the network, or both.

For example, referring to the third monitoring configuration 405-c, the UE 115 may receive a message indicating a deactivation of the first serving cell 410-a. In this example, and in cases where the UE 115 is configured to perform cell group basis activation, the UE 115 may be configured to ignore the deactivation due to the fact that other serving cells 410-b, 410-c within the serving cell group are still activated.

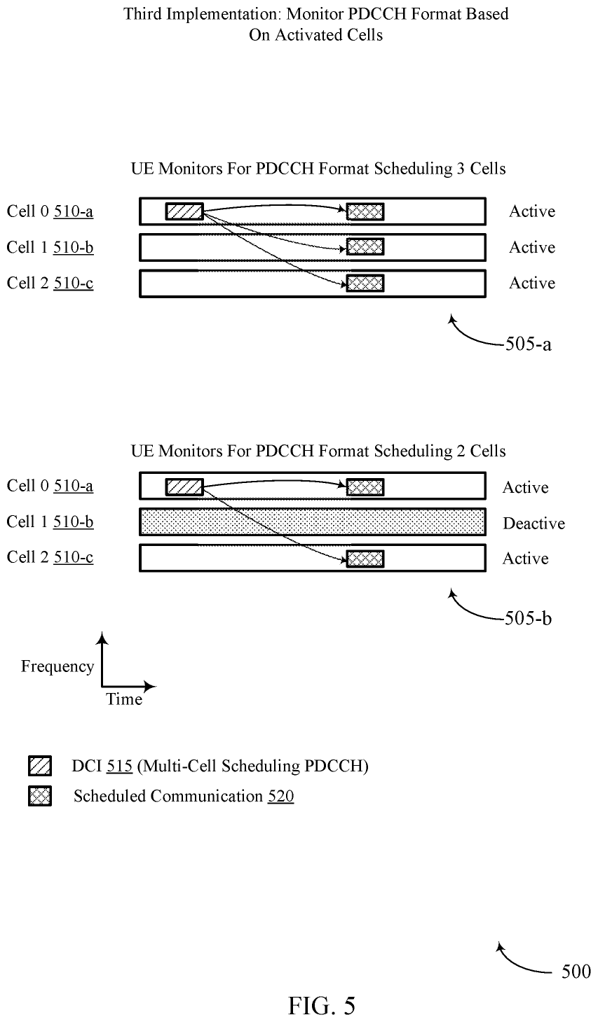

FIG. 5 illustrates an example of a resource configuration 500 that supports techniques for multi-cell scheduling in accordance with one or more aspects of the present disclosure. Aspects of the resource configuration 500 may implement, or be implemented by, the wireless communications system 100, the wireless communications system 200, the resource configuration 300, the resource configuration 400, or any combination thereof.

The resource configuration 500 includes different monitoring configurations 505-a, 505-b which illustrate different examples for PDCCH monitoring in the context of multi-cell scheduling. Each monitoring configuration 505 illustrates a serving cell group which may be configured at a UE 115, where the serving cell group includes a first serving cell 510-a (Cell 0), a second serving cell 510-b (Cell 1), and a third serving cell 510-c (Cell 2). The serving cells 510-a, 510-b, and 510-c illustrated in FIG. 5 may be examples of the serving cells 210-a, 210-b, and 210-c illustrated in FIG. 2.

In particular, the resource configuration 500 illustrated in FIG. 5 illustrates a third implementation, a third rule, or a third condition that may be used by a UE 115 when determining whether or not the UE 115 is expected to monitor for multi-cell scheduling for a serving cell group. In accordance with the third implementation, the UE 115 may monitor for multi-cell scheduling messages associated with a PDCCH format (e.g., DCI format) that is based on the quantity of activated serving cells 510 within the serving cell group.

In other words, the UE 115 may be configured to select and monitor a PDCCH format that is based on the activation state of the serving cells 410 in the group. In such cases, the UE 115 may be configured with multiple DCI formats, where each DCI format corresponds to a quantity of activated serving cells 510 (e.g., first DCI format for three activated serving cells 510, second DCI format for five activated serving cells 510, third DCI format for two activated serving cells 510, etc.). The UE 115 may then be configured to select and monitor the respective DCI format depending on the quantity of activated serving cells 510 in the serving cell group.

In some aspects, the UE 115 may be instructed (e.g., by a network entity 105) and/or preconfigured to monitor for multi-cell scheduling messages in accordance with the third implementation shown and described in FIG. 5. For example, in some cases, a network entity 105 may indicate a multi-cell scheduling configuration which includes a condition that the UE 115 is expected to monitor for multi-cell scheduling messages including a PDCCH format (e.g., DCI format) that is based on the activation states of the serving cells 510 in the serving cell group (in accordance with the third implementation). Moreover, in some cases, the UE 115 may be configured with a multi-cell scheduling configuration which instructs the UE 115 to monitor for multi-cell scheduling messages in accordance with the first implementation shown and described in FIG. 3, in accordance with the second implementation shown and described in FIG. 4, and/or in accordance with the third implementation shown and described in FIG. 5.

For instance, referring to the first monitoring configuration 505-a, each of the serving cells 510-a, 510-b, and 510-c may be in an activated state. As such, the UE 115 may be configured to monitor for DCI messages 515 associated with a DCI format that is used to schedule communications 520 for three serving cells 510.

Comparatively, referring to the second monitoring configuration 505-b, the first serving cell 510-a and the third serving cell 510-c may be activated, where the second serving cell 510-b is deactivated. In this example, the UE 115 may be configured to monitor for DCI messages 515 associated with a DCI format that is used to schedule communications 520 for two serving cells 510. In some cases, different combinations of activated serving cells 510 may be associated with different PDCCH formats (e.g., first DCI format for scheduling Cells 0 and 1, second DCI format for scheduling Cells 0 and 2, third DCI format for scheduling Cells 1 and 2, etc.).

FIG. 6 illustrates an example of a resource configuration 600 that supports techniques for multi-cell scheduling in accordance with one or more aspects of the present disclosure. Aspects of the resource configuration 600 may implement, or be implemented by, the wireless communications system 100, the wireless communications system 200, the resource configuration 300, the resource configuration 400, the resource configuration 500, or any combination thereof.

The resource configuration 600 includes different timer configurations 605-a, 605-b which illustrate different examples for restarting activation timers for serving cells 610 based on multi-cell scheduling messages. Each timer configuration 605 illustrates a serving cell group which may be configured at a UE 115, where the serving cell group includes a first serving cell (Cell 0), a second serving cell (Cell 1), and a third serving cell (Cell 2). The serving cells described in FIG. 6 may be examples of the serving cells 210-a, 210-b, and 210-c illustrated in FIG. 2.

Moreover, each serving cell (e.g., Cells 0, 1, 2) described in FIG. 6 may be associated with a respective timer that is associated with the activation state (e.g., activation timer, SCell deactivation timer, etc.) of the respective serving cell. For example, as shown in FIG. 6, the first serving cell may be associated with a first activation timer 615-a, the second serving cell may be associated with a second activation timer 615-b, and the third serving cell may be associated with a third activation timer 615-c. The relative “height” or “width” of the activation timers 615 may illustrate the remaining duration of the timers until expiration. That is, the larger the height/width of the activation timer 615, the longer duration until expiration of the activation timer 615. Conversely, the smaller the height/width of the activation timer 615, the shorter duration until expiration of the activation timer 615.

As noted previously herein, the UE 115 and the network may implement various rules or conditions for restarting activation timers 615 for serving cells of a serving cell group upon receiving/transmitting multi-cell scheduling messages for the serving cell group.

For example, in accordance with a first implementation for restarting timers in the context of multi-cell scheduling, the UE 115 and the network may be configured to restart activation timers 615 for all serving cells in a serving cell group upon receiving/transmitting a multi-cell scheduling message for the serving cell group. In other words, the UE 115 and/or network entity 105 may be configured to restart activation timers 615 for all serving cells of the group regardless of whether the multi-cell scheduling message actually allocates resources for each serving cell of the serving cell group.

For instance, referring to the first timer configuration 605-a, a UE 115-b may receive a message (e.g., MAC-CE) from a network entity 105-b at 610, where the message indicates and/or activates three serving cells of a serving cell group. Subsequently, at 620, the UE 115-b may receive a multi-cell scheduling message (e.g., DCI) which allocates resources (e.g., RBs) for Cell 0, but does not allocate resources for Cells 1 and 2. In this example, in accordance with the first implementation for restarting timers, the UE 115-b may be configured to restart the activation timers 615-a, 615-b, 615-c for all the serving cells of the serving cell group based on receiving the multi-cell scheduling message (and despite the message not allocating any resources for Cells 1 and 2).

In additional or alternative implementations, rather than a binary determination for allocation of resources (e.g., Yes, No), the determination may be based on a quantity of resource blocks which are allocated. In other words, the UE 115-a may determine that resources are “allocated” for a serving cell if the quantity of scheduled/indicated RBs is greater than some threshold quantity, and may determine that resources are not allocated for a serving cell if the quantity of scheduled/indicated RBs is less than the threshold quantity.

By way of another example, in accordance with a second implementation for restarting timers in the context of multi-cell scheduling, the UE 115 and the network may be configured to restart activation timers 615 only for serving cells which actually received an allocation of resources (and/or for serving cells which were scheduled with a quantity of RBs greater than some threshold quantity). In other words, the UE 115 and/or network entity 105 may be configured to restart activation timers 615 only for those serving cells for which the multi-cell scheduling message actually allocated resources (or allocated a quantity of RBs that is greater than the threshold quantity).

For instance, referring to the second timer configuration 605-b, a UE 115-c may receive a message (e.g., MAC-CE) from a network entity 105-c at 625, where the message indicates and/or activates three serving cells of a serving cell group. Subsequently, at 630, the UE 115-c may receive a multi-cell scheduling message (e.g., DCI) which allocates resources (e.g., RBs) for Cell 0, but does not allocate resources for Cells 1 and 2. In this example, in accordance with the second implementation for restarting timers, the UE 115-c may be configured to restart the activation timer 615-a for Cell 0 based on the multi-cell scheduling message actually scheduling resources within Cell 0 (and/or based on the quantity of RBs allocated for Cell 0 satisfying/exceeding a threshold quantity). Comparatively, in accordance with the second implementation, the UE 115-c may not restart activation timers 615-b and 615-c associated with Cells 1 and 2 based on the multi-cell scheduling message not actually scheduling resources within Cells 1 and 2 (and/or based on the quantities of RBs allocated for Cells 1 and 2 failing to satisfy the threshold quantity).

FIG. 7 illustrates an example of a process flow 700 that supports techniques for multi-cell scheduling in accordance with one or more aspects of the present disclosure. Aspects of the process flow 700 may implement, or be implemented by, aspects of the wireless communications system 100, the wireless communications system 200, the resource configuration 300, the resource configuration 400, the resource configuration 500, the resource configuration 600, or any combination thereof. For example, the process flow 700 may illustrate a UE 115-d determining whether to monitor for multi-cell scheduling messages, and restarting activation timers based on received multi-cell scheduling messages, as described with reference to FIGS. 1-6.

In some cases, process flow 700 may include a UE 115-d and a network entity 105-d, which may be examples of corresponding devices as described herein. In particular, the UE 115-d and the network entity 105-d illustrated in FIG. 7 may include examples of the UE 115-a and the network entity 105-a illustrated in FIG. 2, and/or the UEs 115-b, 115-c and network entities 105-b, 105-c illustrated in FIG. 6.

In some examples, the operations illustrated in process flow 700 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 705, the UE 115-d may receive control signaling (e.g., RRC, MAC-CE, DCI, SIB, etc.) from the network entity 105-d. In some aspects, the control signaling may indicate a serving cell group including a set of serving cells (e.g., PCells, SCells) usable for communications at the UE 115-d. In some cases, the serving cells of the serving cell group may be associated with (e.g., supported by) the network entity 105-d, an additional network entity 105, or both.

In some implementations, the control signaling may additionally or alternatively configure the UE 115-d with a multi-cell scheduling configuration. The multi-cell scheduling configuration may include one or more rules or conditions associated with when the UE 115-d is expected to monitor for multi-cell scheduling messages, when the UE 115-d is expected to restart activation timers based on received multi-cell scheduling messages, how the UE 115-d is to identify and/or report mismatches between perceived activation states, and the like.

Stated differently, the network entity 105-d may configure the UE 115-d with a multi-cell scheduling configuration that includes one or more conditions associated with monitoring for multi-cell scheduling messages for the serving cell group, one or more conditions for restarting activation timers for serving cells of the serving cell group, and the like. For example, the multi-cell scheduling configuration may instruct the UE 115-a to follow the first implementation for multi-cell scheduling illustrated in FIG. 3, the second implementation illustrated in FIG. 4, or the third implementation illustrated in FIG. 5. Similarly, the multi-cell scheduling configuration may indicate whether the UE 115-d is to follow the first timer configuration 605-a or the second timer configuration 605-b, as illustrated in FIG. 6.

At 710, the UE 115-d, the network entity 105-d, or both, may determine activation states associated with one or more serving cells of the serving cell group. In other words, the UE 115-d and/or the network entity 105-d may determine whether each serving cell is in an active state, a deactive state, or some other activation/operational state. In some aspects, the UE 115-d and/or the network entity 105-d may determine the activation states at 710 based on receiving/transmitting the control signaling at 705.

At 715, the UE 115-d may determine whether or not to monitor for multi-cell scheduling messages (e.g., DCI messages) for the serving cell group. Similarly, the network entity 105-d may determine whether or not to transmit multi-cell scheduling messages for the serving cell group. In some cases, the devices may perform the determination at 715 based on communicating the control signaling at 715, determining the activation states of the respective serving cells at 710, or both. In particular, the UE 115-d may be configured to determine whether or not to monitor for multi-cell scheduling messages based on whether the one or more conditions of the multi-cell scheduling configuration (indicated at 705) are satisfied or not.

For example, in some cases, the UE 115-d may determine to monitor for multi-cell scheduling messages (and the network entity 105-d may determine to transmit the multi-cell scheduling messages) based on each serving cell of the serving cell group being in an active state (as shown and described in FIG. 3). By way of another example, in other cases, the UE 115-d may determine to monitor for multi-cell scheduling messages (and the network entity 105-d may determine to transmit the multi-cell scheduling messages) based on at least one serving cell of the serving cell group being in an active state (as shown and described in FIG. 4).

In cases where the respective devices determine to monitor/transmit multi-cell scheduling messages, the process flow 700 may proceed to 720. However, it is noted herein that, even in cases where the UE 115-d does not monitor for multi-cell scheduling messages, the UE 115-d may be configured to monitor for other types of control messages, such as self-scheduling messages and/or cross-carrier scheduling messages. In such cases, multi-cell scheduling messages, self-scheduling messages, and/or cross-carrier scheduling messages may be associated with different control message formats and/or different scheduling resources. As such, even in cases where the UE 115-d does not monitor resources/message formats for multi-cell scheduling messages, the UE 115-d may still monitor resources and/or message formats associated with self-scheduling messages and/or cross-carrier scheduling messages.

At 720, the UE 115-d and/or the network entity 105-b may determine a control message format (e.g., PDCCH format, DCI format) that will be used for multi-cell scheduling messages. In some aspects, the devices may determine the PDCCH format at 720 based on communicating the control signaling at 705, determining the activation state(s) of serving cells at 710, determining to monitor/transmit multi-cell scheduling messages at 715, or any combination thereof.

For example, in some cases, the control message format may be based on the activation states of the respective serving cells of the serving cell group. In particular, the control message format may be associated with a quantity of serving cells in the serving cell group which are in an activated state, as shown and described in FIG. 5. In other words, the UE 115-d may be configured with multiple DCI formats (e.g., via control signaling at 705), where each DCI format corresponds to a quantity of activated serving cells in the serving cell group (e.g., first DCI format for three activated serving cells, second DCI format for five activated serving cells, third DCI format for two activated serving cells, etc.).

At 725, the UE 115-d may monitor at least a portion of control signaling (e.g., a portion of a PDCCH channel) for multi-cell scheduling messages associated with the serving cell group. Similarly, at 730, the network entity 105-d may transmit one or more multi-cell scheduling messages (e.g., DCI messages) for the serving cell group within a portion of control signaling configured for multi-cell scheduling.

The UE 115-d may perform the monitoring at 725, and the network entity 105-d may transmit the messages at 730, based on communicating the control signaling at 705, determining the activation states at 710, determining to monitor/transmit multi-cell scheduling messages at 715, determining the control message format at 720, or any combination thereof.

For example, in cases where the UE 115-d is configured with a multi-cell scheduling configuration, the UE 115-d may perform the monitoring at 725 based on the satisfaction of the one or more conditions of the multi-cell scheduling configuration associated with monitoring for multi-cell scheduling messages. By way of another example, the UE 115-d may monitor for (and the network entity 105-d may transmit) multi-cell scheduling messages that exhibit the control message format (e.g., DCI format) which was determined at 720.

In some aspects, the multi-cell scheduling message may allocate resources usable for communications over one or more serving cells of the serving cell group. For example, in some cases, the multi-cell scheduling message may allocate resources for each serving cell of the serving cell group. By way of another example, as shown in FIG. 6, the multi-cell scheduling message may allocate resources for some serving cells of the serving cell group, and may indicate that no resources are allocated for other serving cells of the group.

At 735, the UE 115-d, the network entity 105-d, or both, may restart one or more activation timers associated with one or more serving cells of the serving cell group. The UE 115-d and/or the network entity 105-d may restart the activation timers at 735 based on communicating the control signaling at 705, determining the activation states at 710, determining to monitor/transmit multi-cell scheduling messages at 715, determining the control message format at 720, performing the monitoring at 725, communicating the multi-cell scheduling messages at 730, or any combination thereof.

For example, in cases where the UE 115-d is configured with a multi-cell scheduling configuration, the UE 115-d may restart one or more activation timers at 735 based on the satisfaction of the one or more conditions of the multi-cell scheduling configuration associated with restarting activation timers. For instance, in some cases, as shown in the first timer configuration 605-a in FIG. 6, the UE 115-d and the network entity 105-d may restart activation timers for every serving cell in the serving cell group based on receiving/transmitting the multi-cell scheduling message at 730.

In additional or alternative cases, as shown in the second timer configuration 605-b in FIG. 6, the UE 115-d and the network entity 105-d may restart activation timers only for those serving cells of the serving cell group for which the multi-cell scheduling message actually included a resource allocation (and/or for those serving cells that were allocated a quantity of RBs that satisfy some threshold quantity). For instance, the multi-cell scheduling message may allocate a first quantity of RBs to a first serving cell of the serving cell group, and may indicate that no RBs are allocated to a second serving cell of the serving cell group. In this example, the UE 115-d may restart the activation timer for the first serving cell, but may refrain from restarting the activation timer for the second serving cell. By way of another example, the multi-cell scheduling message may allocate a first quantity of RBs to a first serving cell of the serving cell group, and may allocate a second quantity of RBs to a second serving cell of the serving cell group. In this example, the UE 115-d may restart the activation timer for the first serving cell based on the first quantity of RBs satisfying a threshold quantity, but may refrain from restarting the activation timer for the second serving cell based on the second quantity of RBs failing to satisfy the threshold quantity.

At 740, the UE 115-d may be configured to identify a mismatch between perceived activation states of serving cells in the group between the UE 115-d and the network entity 105-d. In other words, the UE 115-a may be configured to identify cases where the UE 115-d has determined the serving cell to be in a deactivated state, but the network entity 105-d has determined the serving cell to be in an activated state (or vice versa). In some cases, the UE 115-d may perform the determination/evaluation at 740 based on receiving the multi-cell scheduling message at 730.

For example, the UE 115-d may determine that a serving cell of the serving cell group is in a deactivated state, and may subsequently receive the multi-cell scheduling message that allocates resources for the serving cell. In this example, the UE 115-d may determine a mismatch between perceived operational states at the UE 115-d and the network entity 105-d (e.g., the UE 115-d thinks the serving cell is deactivated, where the network entity 105-d thinks the serving cell is activated).

In cases where the UE 115-d identifies a mismatch between perceived activation states, the UE 115-d may perform several operations to report and/or correct the identified mismatch. For example, continuing with the example above, the UE 115-d may be configured to activate the serving cell to correct the mismatch and align the perceived activation states of the serving cell across the UE 115-d and the network entity 105-d. Similarly, in cases where the UE 115-d thinks the serving cell is in an activated state, but the network entity 105-d thinks the serving cell is in a deactivated state, the UE 115-d may deactivate the serving cell to address the identified mismatch.

In additional or alternative implementations, the UE 115-d may report the identified mismatch to the network entity 105-d. For example, the UE 115-d may transmit a HARQ feedback message to the network entity 105-d in response to the multi-cell scheduling message (e.g., in response to resource allocations indicated via the multi-cell scheduling message). For instance, the UE 115-a may transmit an ACK message in cases where the UE 115-d intends to prevent unnecessary HARQ retransmission from the network, and may rely on upper layer retransmission (e.g., RLC retransmission). By way of another example, the UE 115-a may transmit a NACK message based on a decoding result of the multi-cell scheduling message (e.g., “no decoding” may be considered to be “unsuccessful decoding”) Additionally, or alternatively, the UE 115-d may refrain from transmitting feedback upon identifying the mis-match (e.g., no feedback).

Additionally, or alternatively, the UE 115-d may simply report the mismatch occurrence to the network entity 105-d. In such cases, the UE 115-d may transmit a report or message (e.g., UCI, PRACH, MAC-CE, RRC, etc.) which indicates an identifier associated with the serving cell (e.g., cell ID, servCellIndex, SCellIndex) and/or the current activation state of the respective serving cell (e.g., active, deactive).

In some aspects, the MAC entity of the UE 115-d may (internally) inform upper layers/components, such as the RLC entity, of the identified mismatch. In such cases, the RLC entity may trigger the UE 115-c to transmit a status report messages to the network entity 105-d so that the network entity 105-d may trigger RLC retransmission for the dropped downlink data.

At 745, the UE 115-d may receive a message (e.g., MAC-CE) from the network entity 105-d which indicates for the UE 115-d to deactivate a serving cell of the serving cell group. In some cases, the network entity 105-d may trigger the deactivation based on an expiration of an activation timer, to reduce power consumption at the network entity 105-d and/or UE 115-d, to improve network resource utilization, or any combination thereof. As such, in some cases, the network entity 105-d may transmit the message at 745 based on transmitting the multi-cell scheduling message at 730, restarting activation timers at 735, or both.

At 750, the UE 115-d, the network entity 105-d, or both, may deactivate the serving cell of the serving cell group. The UE 115-d, the network entity 105-d, or both, may deactivate the serving cell based on receiving/transmitting the multi-cell scheduling message at 730, restarting activation timers at 735, receiving/transmitting the message at 745, or any combination thereof.

For example, in some cases, the UE 115-d may deactivate the serving cell (e.g., transition the serving cell from an activated state to a deactivated state) in response to receiving the message at 745. In additional or alternative implementations, the UE 115-d may deactivate the serving cell based on an expiration of an activation timer associated with the serving cell (with or without receiving an explicit deactivation from the network entity 105-d). In some cases, the UE 115-d and the network entity 105-d may perform cell group basis deactivation, and may therefore deactivate each serving cell of the serving cell group based on deactivating any cell of the group.

In some cases, the UE 115-d and the network entity 105-d may be configured to repeat the steps/operations shown in process flow 700. For example, upon deactivating one or more serving cells of the serving cell group, the UE 115-d and the network entity 105-d may then be configured to re-evaluate the activation states of the serving cells of the serving cell group at 710, determine whether or not to monitor for (or transmit) multi-cell scheduling messages at 715 based on the newly determined activation states, etc.

Techniques described herein may resolve ambiguities associated with multi-cell scheduling techniques, which may enable more efficient and reliable use of multi-cell scheduling. In particular, techniques described herein may enable the UE 115-d to determine whether or not to monitor for multi-cell scheduling messages, which may reduce a quantity of retransmissions for multi-cell scheduling, thereby improving resource utilization and reducing power consumption at the respective devices. Moreover, techniques described herein may enable the UE 115-d to determine when to restart activation timers for serving cells upon receiving a multi-cell scheduling message, which may improve coordination between the UE 115-d and the network entity 105-d and reduce mis-matches between perceived activation states of serving cells at the UE 115-d and the network entity 105-d, which may improve an efficiency and reliability of wireless communications via the respective serving cells.

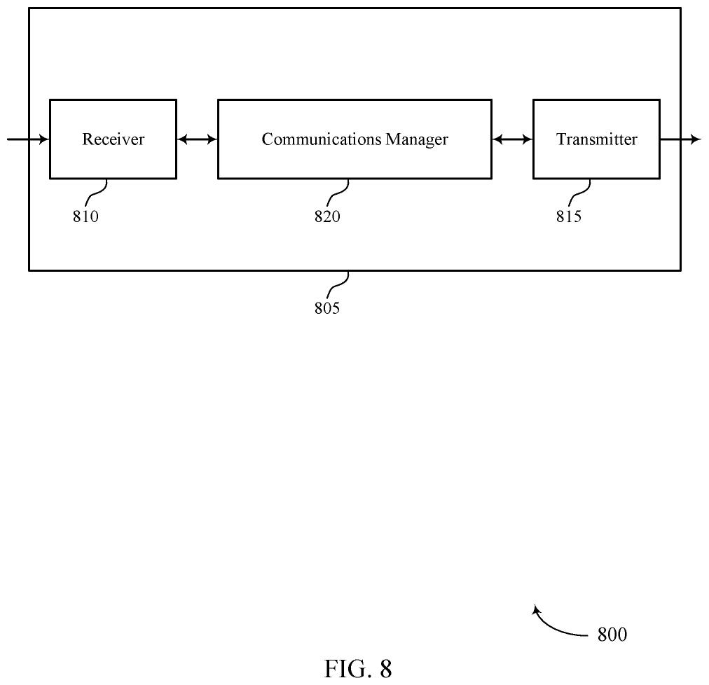

FIG. 8 illustrates a block diagram 800 of a device 805 that supports techniques for multi-cell scheduling in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for multi-cell scheduling). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for multi-cell scheduling). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for multi-cell scheduling as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 may be configured as or otherwise support a means for receiving, from a network entity, a control message indicating a serving cell group including a set of multiple serving cells usable for wireless communications at the UE. The communications manager 820 may be configured as or otherwise support a means for determining whether to monitor for a multi-cell scheduling message based on activation states of the set of multiple serving cells of the serving cell group, where the multi-cell scheduling message includes scheduling information for multiple serving cells of the set of multiple serving cells. The communications manager 820 may be configured as or otherwise support a means for monitoring, in accordance with the determination, at least a portion of control signaling that includes the multi-cell scheduling message.

By including or configuring the communications manager 820 in accordance with examples as described herein, the device 805 (e.g., a processor controlling or otherwise coupled with the receiver 810, the transmitter 815, the communications manager 820, or a combination thereof) may support techniques used to resolve ambiguities associated with multi-cell scheduling techniques, which may enable more efficient and reliable use of multi-cell scheduling. In particular, techniques described herein may enable UEs 115 to determine whether or not to monitor for multi-cell scheduling messages, which may reduce a quantity of retransmissions for multi-cell scheduling, thereby improving resource utilization and reducing power consumption at the respective devices. Moreover, techniques described herein may enable UEs 115 to determine when to restart activation timers for serving cells upon receiving a multi-cell scheduling message, which may improve coordination between the UEs 115 and the network and reduce mis-matches between perceived activation states of serving cells at the UEs 115 and the network, which may improve an efficiency and reliability of wireless communications via the respective serving cells.

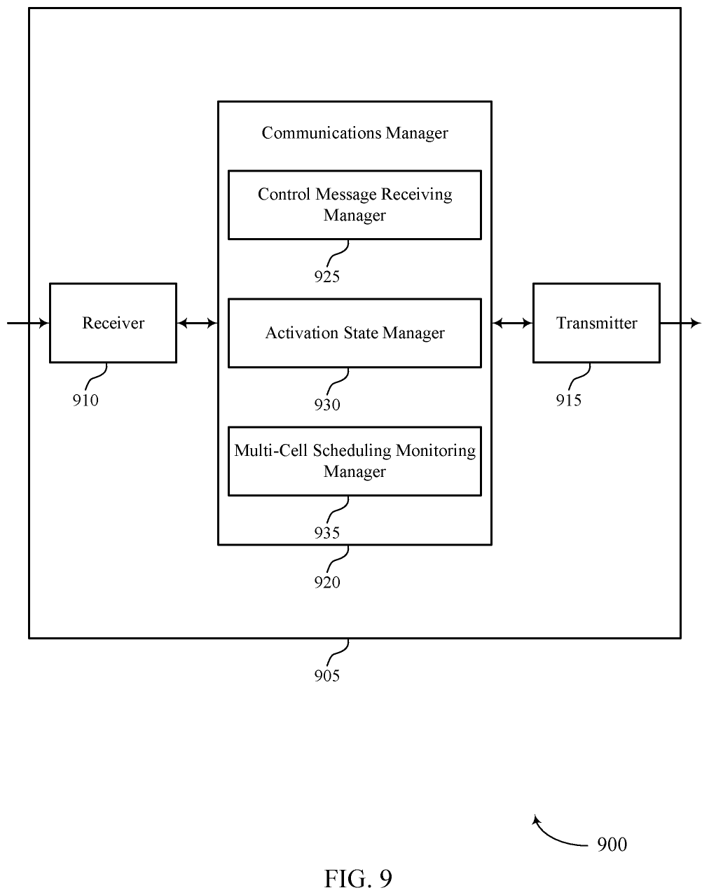

FIG. 9 illustrates a block diagram 900 of a device 905 that supports techniques for multi-cell scheduling in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for multi-cell scheduling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for multi-cell scheduling). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for multi-cell scheduling as described herein. For example, the communications manager 920 may include a control message receiving manager 925, an activation state manager 930, a multi-cell scheduling monitoring manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The control message receiving manager 925 may be configured as or otherwise support a means for receiving, from a network entity, a control message indicating a serving cell group including a set of multiple serving cells usable for wireless communications at the UE. The activation state manager 930 may be configured as or otherwise support a means for determining whether to monitor for a multi-cell scheduling message based on activation states of the set of multiple serving cells of the serving cell group, where the multi-cell scheduling message includes scheduling information for multiple serving cells of the set of multiple serving cells. The multi-cell scheduling monitoring manager 935 may be configured as or otherwise support a means for monitoring, in accordance with the determination, at least a portion of control signaling that includes the multi-cell scheduling message.

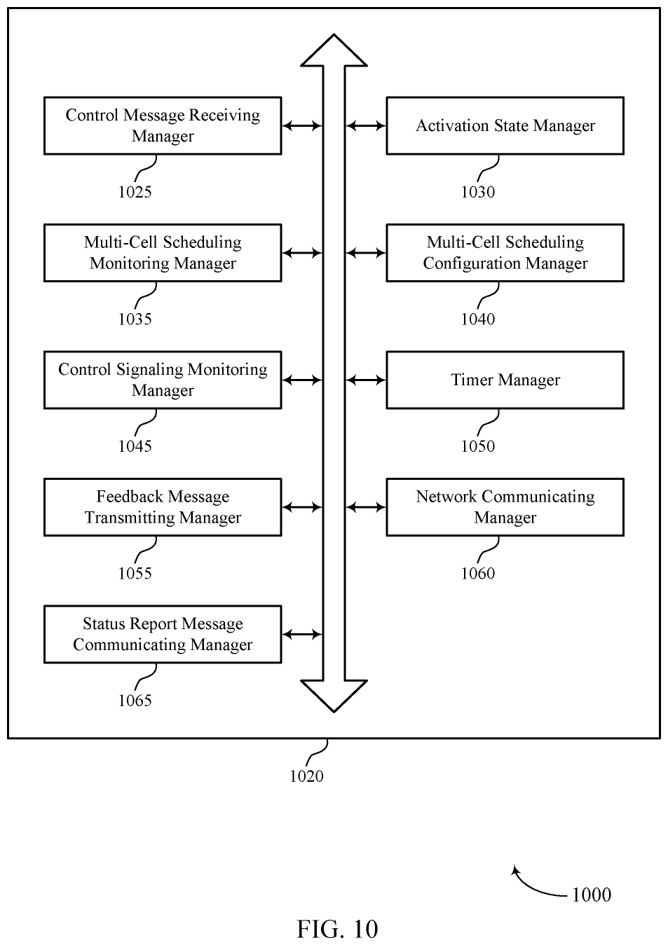

FIG. 10 illustrates a block diagram 1000 of a communications manager 1020 that supports techniques for multi-cell scheduling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for multi-cell scheduling as described herein. For example, the communications manager 1020 may include a control message receiving manager 1025, an activation state manager 1030, a multi-cell scheduling monitoring manager 1035, a multi-cell scheduling configuration manager 1040, a control signaling monitoring manager 1045, a timer manager 1050, a feedback message transmitting manager 1055, a network communicating manager 1060, a status report message communicating manager 1065, or any combination thereof. Each of these components may communicate, directly or indirectly, with one another (e.g., via one or more buses).

The control message receiving manager 1025 may be configured as or otherwise support a means for receiving, from a network entity, a control message indicating a serving cell group including a set of multiple serving cells usable for wireless communications at the UE. The activation state manager 1030 may be configured as or otherwise support a means for determining whether to monitor for a multi-cell scheduling message based on activation states of the set of multiple serving cells of the serving cell group, where the multi-cell scheduling message includes scheduling information for multiple serving cells of the set of multiple serving cells. The multi-cell scheduling monitoring manager 1035 may be configured as or otherwise support a means for monitoring, in accordance with the determination, at least a portion of control signaling that includes the multi-cell scheduling message.

In some examples, to support determining whether to monitor for the multi-cell scheduling message, the multi-cell scheduling monitoring manager 1035 may be configured as or otherwise support a means for determining to monitor for the multi-cell scheduling message based on each of the set of multiple serving cells of the serving cell group being in an activated state at the UE.

In some examples, to support determining whether to monitor for the multi-cell scheduling message, the multi-cell scheduling monitoring manager 1035 may be configured as or otherwise support a means for determining to monitor for the multi-cell scheduling message based on at least one serving cell of the set of multiple serving cells of the serving cell group being in an activated state at the UE.

In some examples, the activation state manager 1030 may be configured as or otherwise support a means for determining a set of multiple activation states associated with the set of multiple serving cells of the serving cell group. In some examples, the multi-cell scheduling monitoring manager 1035 may be configured as or otherwise support a means for determining a control message format associated with the multi-cell scheduling message based on the set of multiple activation states, where monitoring at least the portion of the control signaling includes monitoring for the control message format associated with the multi-cell scheduling message.

In some examples, the multi-cell scheduling configuration manager 1040 may be configured as or otherwise support a means for receiving, from the network entity, a multi-cell scheduling configuration including one or more conditions associated with monitoring for the multi-cell scheduling message based on activation states of the set of multiple serving cells of the serving cell group, where the monitoring is performed based on a satisfaction of the one or more conditions of the multi-cell scheduling configuration.

In some examples, the control message receiving manager 1025 may be configured as or otherwise support a means for receiving, from the network entity, a message indicating a deactivation of at least one serving cell of the serving cell group. In some examples, the activation state manager 1030 may be configured as or otherwise support a means for deactivating each of the set of multiple serving cells of the serving cell group based on the message.

In some examples, the multi-cell scheduling monitoring manager 1035 may be configured as or otherwise support a means for refraining from monitoring for an additional multi-cell scheduling message for the serving cell group throughout a second time interval subsequent to the first time interval. In some examples, the control signaling monitoring manager 1045 may be configured as or otherwise support a means for monitoring the control signaling throughout the second time interval for a self-scheduling message associated with one or more serving cells of the serving cell group, a cross-carrier scheduling message associated with one or more serving cells of the serving cell group, or both.

In some examples, the timer manager 1050 may be configured as or otherwise support a means for restarting a set of multiple timers associated with activation states of the set of multiple serving cells of the serving cell group based on receiving the multi-cell scheduling message.

In some examples, the multi-cell scheduling monitoring manager 1035 may be configured as or otherwise support a means for receiving, via the multi-cell scheduling message, a first indication of a first quantity of RBs allocated for communications with the UE via the first serving cell, and a second indication of a second quantity of RBs allocated for communications with the UE via the second serving cell. In some examples, the timer manager 1050 may be configured as or otherwise support a means for restarting a first timer associated with a first activation state of the first serving cell based on the first quantity of RBs satisfying a threshold quantity. In some examples, the timer manager 1050 may be configured as or otherwise support a means for refraining from restarting a second timer associated with a second activation state of the second serving cell based on the second quantity of RBs failing to satisfy the threshold quantity.

In some examples, the timer manager 1050 may be configured as or otherwise support a means for identifying an expiration of the second timer associated with the second serving cell based on refraining from restarting the second timer. In some examples, the activation state manager 1030 may be configured as or otherwise support a means for deactivating the second serving cell based on the expiration of the second timer.

In some examples, the activation state manager 1030 may be configured as or otherwise support a means for deactivating the first serving cell of the serving cell group based on deactivating the second serving cell.

In some examples, the multi-cell scheduling configuration manager 1040 may be configured as or otherwise support a means for receiving, from the network entity, a multi-cell scheduling configuration including one or more conditions for restarting activation timers associated with the set of multiple serving cells of the serving cell group. In some examples, the timer manager 1050 may be configured as or otherwise support a means for restarting one or more activation timers associated with one or more serving cells of the serving cell group based on a satisfaction of the one or more conditions of the multi-cell scheduling configuration.

In some examples, the multi-cell scheduling monitoring manager 1035 may be configured as or otherwise support a means for receiving, via the multi-cell scheduling message, an indication of a set of RBs allocated for communications with the UE via the first serving cell. In some examples, the feedback message transmitting manager 1055 may be configured as or otherwise support a means for transmitting a feedback message to the network entity based on the first serving cell being in the deactivated state and based on the set of RBs being allocated for communications via the first serving cell.

In some examples, the multi-cell scheduling monitoring manager 1035 may be configured as or otherwise support a means for receiving, via the multi-cell scheduling message, an indication of a set of RBs allocated for communications with the UE via the first serving cell. In some examples, the network communicating manager 1060 may be configured as or otherwise support a means for transmitting a message to the network entity indicating a mis-match associated with activation states of the first serving cell at the UE and the network entity, the message including a cell identifier associated with the first serving cell and an indication of the deactivated state of the first serving cell at the UE.

In some examples, the message includes a UCI message, a RACH message, a MAC-CE message, an RRC message, or any combination thereof.

In some examples, the multi-cell scheduling monitoring manager 1035 may be configured as or otherwise support a means for receiving, via the multi-cell scheduling message, an indication of a set of RBs allocated for communications with the UE via the first serving cell. In some examples, the activation state manager 1030 may be configured as or otherwise support a means for activating the first serving cell from the deactivated state to an activated state based on the first serving cell being in the deactivated state and based on the set of RBs being allocated for communications via the first serving cell.

In some examples, the status report message communicating manager 1065 may be configured as or otherwise support a means for transmitting a status report message to the network entity based on activating the first serving cell. In some examples, the network communicating manager 1060 may be configured as or otherwise support a means for communicating with the network entity via the first serving cell based on the status report message.

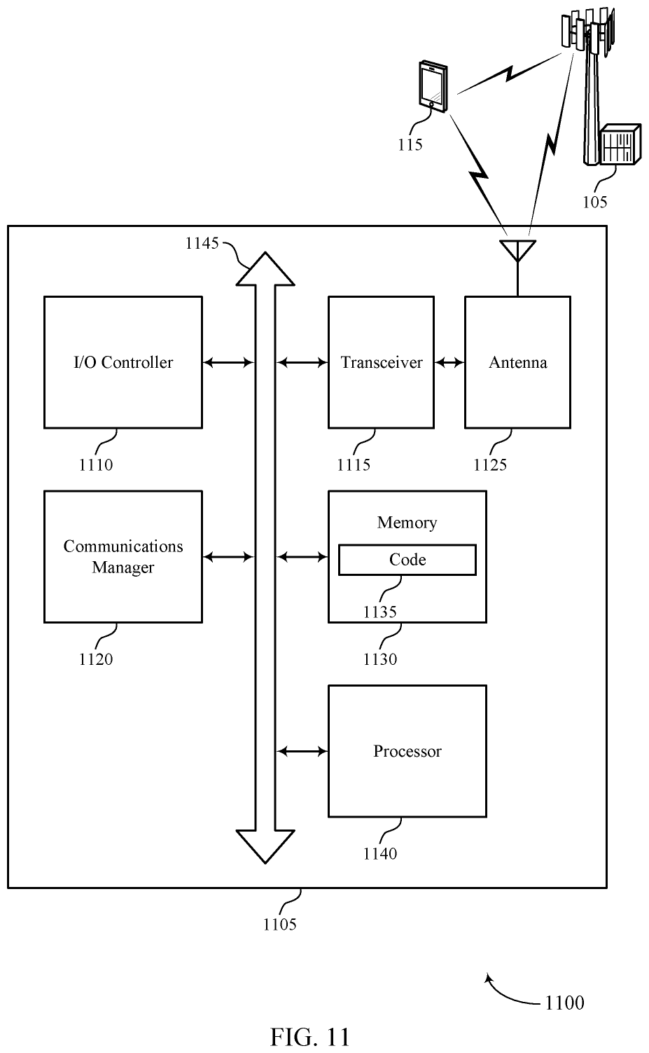

FIG. 11 illustrates a diagram of a system 1100 including a device 1105 that supports techniques for multi-cell scheduling in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for multi-cell scheduling). For example, the device 1105 or a component of the device 1105 may include a processor 1140 and memory 1130 coupled with or to the processor 1140, the processor 1140 and memory 1130 configured to perform various functions described herein.

For example, the communications manager 1120 may be configured as or otherwise support a means for receiving, from a network entity, a control message indicating a serving cell group including a set of multiple serving cells usable for wireless communications at the UE. The communications manager 1120 may be configured as or otherwise support a means for determining whether to monitor for a multi-cell scheduling message based on activation states of the set of multiple serving cells of the serving cell group, where the multi-cell scheduling message includes scheduling information for multiple serving cells of the set of multiple serving cells. The communications manager 1120 may be configured as or otherwise support a means for monitoring, in accordance with the determination, at least a portion of control signaling that includes the multi-cell scheduling message.

By including or configuring the communications manager 1120 in accordance with examples as described herein, the device 1105 may support techniques used to resolve ambiguities associated with multi-cell scheduling techniques, which may enable more efficient and reliable use of multi-cell scheduling. In particular, techniques described herein may enable UEs 115 to determine whether or not to monitor for multi-cell scheduling messages, which may reduce a quantity of retransmissions for multi-cell scheduling, thereby improving resource utilization and reducing power consumption at the respective devices. Moreover, techniques described herein may enable UEs 115 to determine when to restart activation timers for serving cells upon receiving a multi-cell scheduling message, which may improve coordination between the UEs 115 and the network and reduce mis-matches between perceived activation states of serving cells at the UEs 115 and the network, which may improve an efficiency and reliability of wireless communications via the respective serving cells.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for multi-cell scheduling as described herein, or the processor 1140 and the memory 1130 may be otherwise configured to perform or support such operations.

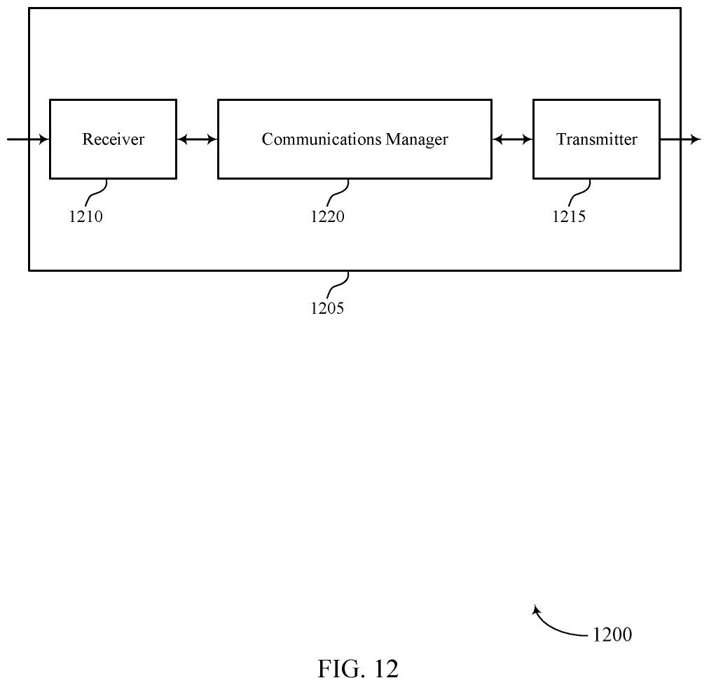

FIG. 12 illustrates a block diagram 1200 of a device 1205 that supports techniques for multi-cell scheduling in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., 1/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for multi-cell scheduling as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

For example, the communications manager 1220 may be configured as or otherwise support a means for transmitting, to a UE, a control message indicating a serving cell group including a set of multiple serving cells usable for wireless communications at the UE. The communications manager 1220 may be configured as or otherwise support a means for determining whether to transmit a multi-cell scheduling message based on activation states of the set of multiple serving cells of the serving cell group, where the multi-cell scheduling message includes scheduling information for multiple serving cells of the set of multiple serving cells. The communications manager 1220 may be configured as or otherwise support a means for transmitting, in accordance with the determination, control signaling that includes the multi-cell scheduling message.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques used to resolve ambiguities associated with multi-cell scheduling techniques, which may enable more efficient and reliable use of multi-cell scheduling. In particular, techniques described herein may enable UEs 115 to determine whether or not to monitor for multi-cell scheduling messages, which may reduce a quantity of retransmissions for multi-cell scheduling, thereby improving resource utilization and reducing power consumption at the respective devices. Moreover, techniques described herein may enable UEs 115 to determine when to restart activation timers for serving cells upon receiving a multi-cell scheduling message, which may improve coordination between the UEs 115 and the network and reduce mis-matches between perceived activation states of serving cells at the UEs 115 and the network, which may improve an efficiency and reliability of wireless communications via the respective serving cells.

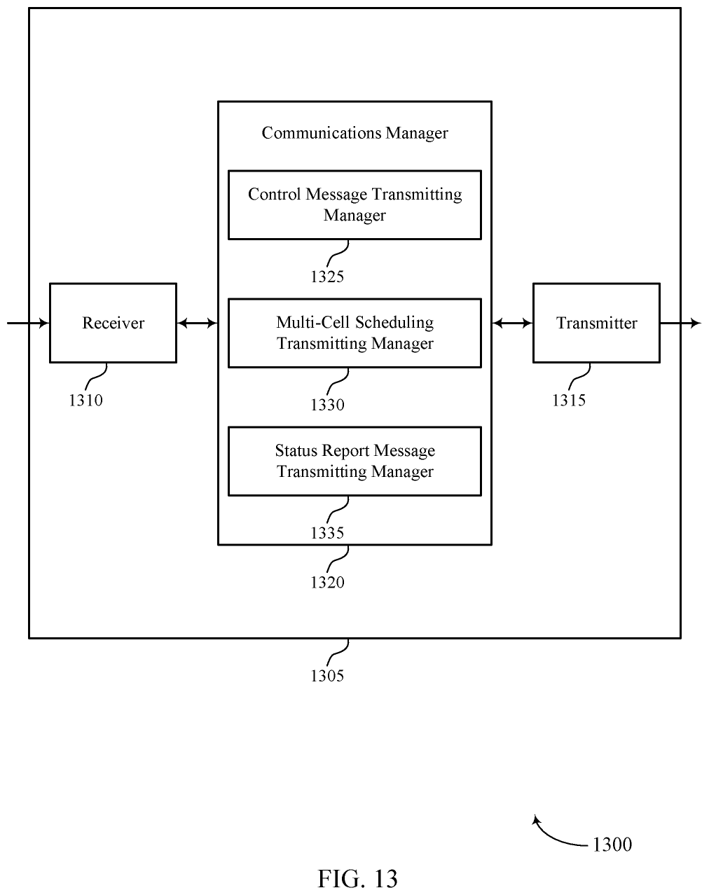

FIG. 13 illustrates a block diagram 1300 of a device 1305 that supports techniques for multi-cell scheduling in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for multi-cell scheduling as described herein. For example, the communications manager 1320 may include a control message transmitting manager 1325, a multi-cell scheduling transmitting manager 1330, a status report message transmitting manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The control message transmitting manager 1325 may be configured as or otherwise support a means for transmitting, to a UE, a control message indicating a serving cell group including a set of multiple serving cells usable for wireless communications at the UE. The multi-cell scheduling transmitting manager 1330 may be configured as or otherwise support a means for determining whether to transmit a multi-cell scheduling message based on activation states of the set of multiple serving cells of the serving cell group, where the multi-cell scheduling message includes scheduling information for multiple serving cells of the set of multiple serving cells. The status report message transmitting manager 1335 may be configured as or otherwise support a means for transmitting, in accordance with the determination, control signaling that includes the multi-cell scheduling message.

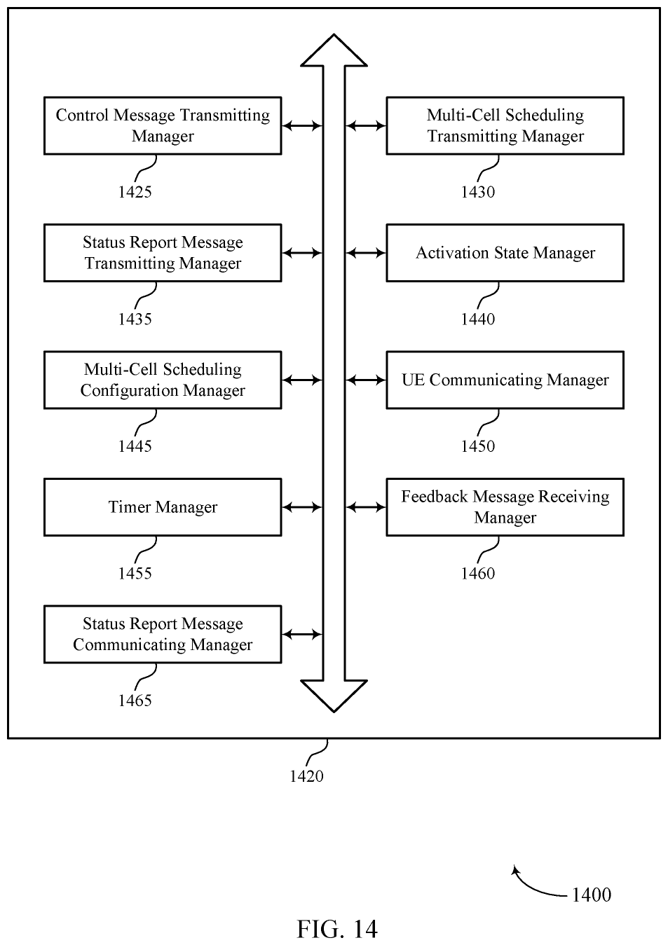

FIG. 14 illustrates a block diagram 1400 of a communications manager 1420 that supports techniques for multi-cell scheduling in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for multi-cell scheduling as described herein. For example, the communications manager 1420 may include a control message transmitting manager 1425, a multi-cell scheduling transmitting manager 1430, a status report message transmitting manager 1435, an activation state manager 1440, a multi-cell scheduling configuration manager 1445, a UE communicating manager 1450, a timer manager 1455, a feedback message receiving manager 1460, a status report message communicating manager 1465, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The control message transmitting manager 1425 may be configured as or otherwise support a means for transmitting, to a UE, a control message indicating a serving cell group including a set of multiple serving cells usable for wireless communications at the UE. The multi-cell scheduling transmitting manager 1430 may be configured as or otherwise support a means for determining whether to transmit a multi-cell scheduling message based on activation states of the set of multiple serving cells of the serving cell group, where the multi-cell scheduling message includes scheduling information for multiple serving cells of the set of multiple serving cells. The status report message transmitting manager 1435 may be configured as or otherwise support a means for transmitting, in accordance with the determination, control signaling that includes the multi-cell scheduling message.

In some examples, to support determining whether to transmit the multi-cell scheduling message, the status report message transmitting manager 1435 may be configured as or otherwise support a means for determining to transmit for the multi-cell scheduling message based on each of the set of multiple serving cells of the serving cell group being in an activated state at the UE.

In some examples, to support determining whether to transmit the multi-cell scheduling message, the multi-cell scheduling transmitting manager 1430 may be configured as or otherwise support a means for determining to transmit for the multi-cell scheduling message based on at least one serving cell of the set of multiple serving cells of the serving cell group being in an activated state at the UE.

In some examples, the activation state manager 1440 may be configured as or otherwise support a means for determining a set of multiple activation states associated with the set of multiple serving cells of the serving cell group. In some examples, the multi-cell scheduling transmitting manager 1430 may be configured as or otherwise support a means for determining a control message format associated with the multi-cell scheduling message based on the set of multiple activation states, where the multi-cell scheduling message is associated with the control message format.

In some examples, the multi-cell scheduling configuration manager 1445 may be configured as or otherwise support a means for transmitting, to the UE, a multi-cell scheduling configuration including one or more conditions associated with the multi-cell scheduling message based on activation states of the set of multiple serving cells of the serving cell group, where transmitting the multi-cell scheduling message is based on a satisfaction of the one or more conditions of the multi-cell scheduling configuration.

In some examples, the UE communicating manager 1450 may be configured as or otherwise support a means for transmitting, to the UE, a message indicating a deactivation of at least one serving cell of the serving cell group. In some examples, the activation state manager 1440 may be configured as or otherwise support a means for deactivating each of the set of multiple serving cells of the serving cell group based on the message.

In some examples, the multi-cell scheduling transmitting manager 1430 may be configured as or otherwise support a means for refraining from transmitting for an additional multi-cell scheduling message for the serving cell group throughout a second time interval subsequent to the first time interval. In some examples, the control message transmitting manager 1425 may be configured as or otherwise support a means for transmitting the control signaling throughout the second time interval for a self-scheduling message associated with one or more serving cells of the serving cell group, a cross-carrier scheduling message associated with one or more serving cells of the serving cell group, or both.

In some examples, the timer manager 1455 may be configured as or otherwise support a means for restarting a set of multiple timers associated with activation states of the set of multiple serving cells of the serving cell group based on transmitting the multi-cell scheduling message.

In some examples, the multi-cell scheduling transmitting manager 1430 may be configured as or otherwise support a means for transmitting, via the multi-cell scheduling message, a first indication of a first quantity of RBs allocated for communications with the UE via the first serving cell, and a second indication of a second quantity of RBs allocated for communications with the UE via the second serving cell. In some examples, the timer manager 1455 may be configured as or otherwise support a means for restarting a first timer associated with a first activation state of the first serving cell based on the first quantity of RBs satisfying a threshold quantity. In some examples, the timer manager 1455 may be configured as or otherwise support a means for refraining from restarting a second timer associated with a second activation state of the second serving cell based on the second quantity of RBs failing to satisfy the threshold quantity.

In some examples, the timer manager 1455 may be configured as or otherwise support a means for identifying an expiration of the second timer associated with the second serving cell based on refraining from restarting the second timer. In some examples, the activation state manager 1440 may be configured as or otherwise support a means for deactivating the second serving cell based on the expiration of the second timer.

In some examples, the activation state manager 1440 may be configured as or otherwise support a means for deactivating the first serving cell of the serving cell group based on deactivating the second serving cell.

In some examples, the multi-cell scheduling configuration manager 1445 may be configured as or otherwise support a means for transmitting, to the UE, a multi-cell scheduling configuration including one or more conditions for restarting activation timers associated with the set of multiple serving cells of the serving cell group. In some examples, the timer manager 1455 may be configured as or otherwise support a means for restarting one or more activation timers associated with one or more serving cells of the serving cell group based on a satisfaction of the one or more conditions of the multi-cell scheduling configuration.

In some examples, the multi-cell scheduling transmitting manager 1430 may be configured as or otherwise support a means for transmitting, via the multi-cell scheduling message, an indication of a set of RBs allocated for communications with the UE via the first serving cell. In some examples, the feedback message receiving manager 1460 may be configured as or otherwise support a means for receiving a feedback message from the UE based on the first serving cell being in the deactivated state at the UE and based on the set of RBs being allocated for communications via the first serving cell.

In some examples, the multi-cell scheduling transmitting manager 1430 may be configured as or otherwise support a means for transmitting, via the multi-cell scheduling message, an indication of a set of RBs allocated for communications with the UE via the first serving cell. In some examples, the UE communicating manager 1450 may be configured as or otherwise support a means for receiving a message from the UE indicating a mis-match associated with activation states of the first serving cell at the UE and the network entity, the message including a cell identifier associated with the first serving cell and an indication that the first serving cell is in a deactivated state at the UE.

In some examples, the message includes a UCI message, a RACH message, a MAC-CE message, an RRC message, or any combination thereof.

In some examples, the status report message communicating manager 1465 may be configured as or otherwise support a means for receiving a status report message from the UE based on the multi-cell scheduling message. In some examples, the UE communicating manager 1450 may be configured as or otherwise support a means for communicating with the UE via a serving cell of the serving cell group based on the status report message.

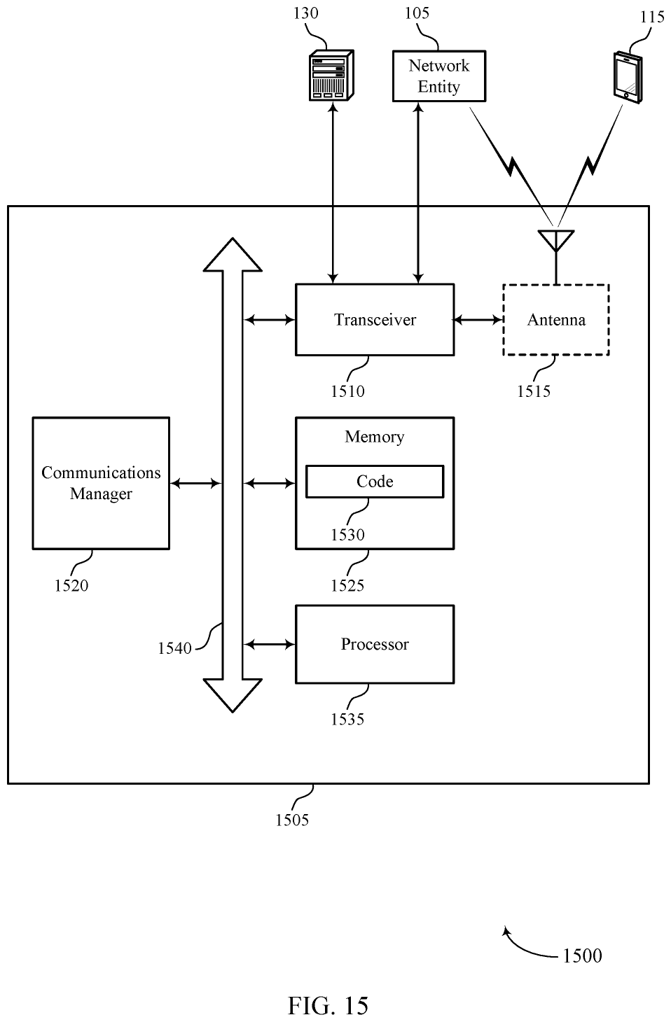

FIG. 15 illustrates a diagram of a system 1500 including a device 1505 that supports techniques for multi-cell scheduling in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for multi-cell scheduling). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

For example, the communications manager 1520 may be configured as or otherwise support a means for transmitting, to a UE, a control message indicating a serving cell group including a set of multiple serving cells usable for wireless communications at the UE. The communications manager 1520 may be configured as or otherwise support a means for determining whether to transmit a multi-cell scheduling message based on activation states of the set of multiple serving cells of the serving cell group, where the multi-cell scheduling message includes scheduling information for multiple serving cells of the set of multiple serving cells. The communications manager 1520 may be configured as or otherwise support a means for transmitting, in accordance with the determination, control signaling that includes the multi-cell scheduling message.

By including or configuring the communications manager 1520 in accordance with examples as described herein, the device 1505 may support techniques used to resolve ambiguities associated with multi-cell scheduling techniques, which may enable more efficient and reliable use of multi-cell scheduling. In particular, techniques described herein may enable UEs 115 to determine whether or not to monitor for multi-cell scheduling messages, which may reduce a quantity of retransmissions for multi-cell scheduling, thereby improving resource utilization and reducing power consumption at the respective devices. Moreover, techniques described herein may enable UEs 115 to determine when to restart activation timers for serving cells upon receiving a multi-cell scheduling message, which may improve coordination between the UEs 115 and the network and reduce mis-matches between perceived activation states of serving cells at the UEs 115 and the network, which may improve an efficiency and reliability of wireless communications via the respective serving cells.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for multi-cell scheduling as described herein, or the processor 1535 and the memory 1525 may be otherwise configured to perform or support such operations.

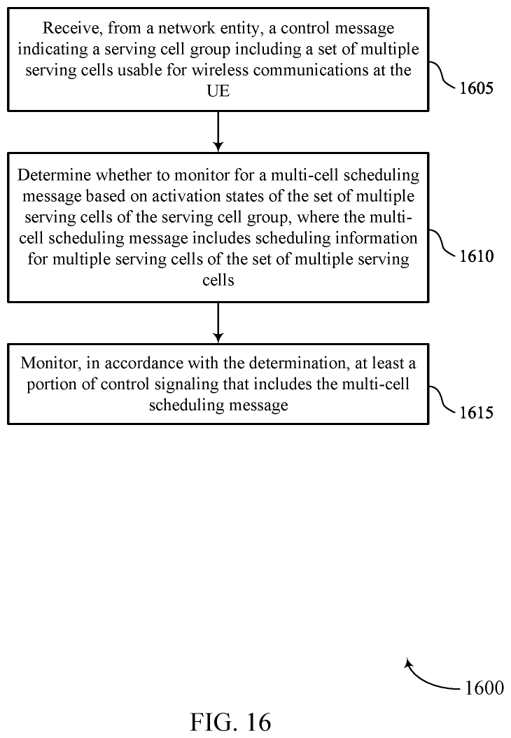

FIG. 16 illustrates a flowchart illustrating a method 1600 that supports techniques for multi-cell scheduling in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a control message indicating a serving cell group including a set of multiple serving cells usable for wireless communications at the UE. The operations of 1605 may be performed in accordance with examples as disclosed herein. In some examples, aspects of the operations of 1605 may be performed by a control message receiving manager 1025 as described with reference to FIG. 10.

At 1610, the method may include determining whether to monitor for a multi-cell scheduling message based on activation states of the set of multiple serving cells of the serving cell group, where the multi-cell scheduling message includes scheduling information for multiple serving cells of the set of multiple serving cells. The operations of 1610 may be performed in accordance with examples as disclosed herein. In some examples, aspects of the operations of 1610 may be performed by an activation state manager 1030 as described with reference to FIG. 10.

At 1615, the method may include monitoring, in accordance with the determination, at least a portion of control signaling that includes the multi-cell scheduling message. The operations of 1615 may be performed in accordance with examples as disclosed herein. In some examples, aspects of the operations of 1615 may be performed by a multi-cell scheduling monitoring manager 1035 as described with reference to FIG. 10.

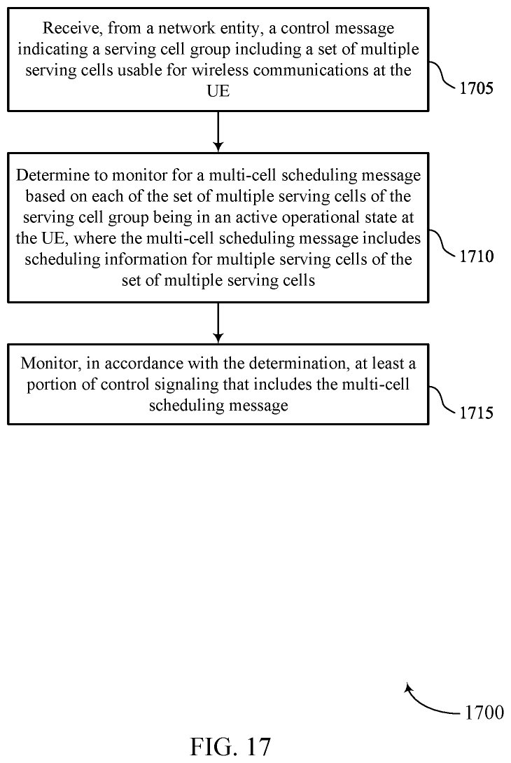

FIG. 17 illustrates a flowchart illustrating a method 1700 that supports techniques for multi-cell scheduling in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a control message indicating a serving cell group including a set of multiple serving cells usable for wireless communications at the UE. The operations of 1705 may be performed in accordance with examples as disclosed herein. In some examples, aspects of the operations of 1705 may be performed by a control message receiving manager 1025 as described with reference to FIG. 10.

At 1710, the method may include determining to monitor for a multi-cell scheduling message based on each of the set of multiple serving cells of the serving cell group being in an activated state at the UE, where the multi-cell scheduling message includes scheduling information for multiple serving cells of the set of multiple serving cells. The operations of 1710 may be performed in accordance with examples as disclosed herein. In some examples, aspects of the operations of 1710 may be performed by an activation state manager 1030 as described with reference to FIG. 10.

At 1715, the method may include monitoring, in accordance with the determination, at least a portion of control signaling that includes the multi-cell scheduling message. The operations of 1715 may be performed in accordance with examples as disclosed herein. In some examples, aspects of the operations of 1715 may be performed by a multi-cell scheduling monitoring manager 1035 as described with reference to FIG. 10.

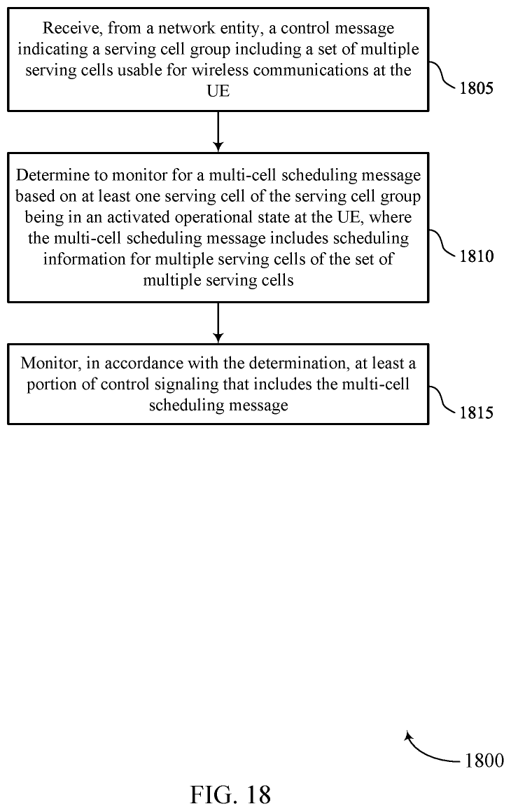

FIG. 18 illustrates a flowchart illustrating a method 1800 that supports techniques for multi-cell scheduling in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, a control message indicating a serving cell group including a set of multiple serving cells usable for wireless communications at the UE. The operations of 1805 may be performed in accordance with examples as disclosed herein. In some examples, aspects of the operations of 1805 may be performed by a control message receiving manager 1025 as described with reference to FIG. 10.

At 1810, the method may include determining to monitor for a multi-cell scheduling message based on at least one serving cell of the serving cell group being in an activated state at the UE, where the multi-cell scheduling message includes scheduling information for multiple serving cells of the set of multiple serving cells. The operations of 1810 may be performed in accordance with examples as disclosed herein. In some examples, aspects of the operations of 1810 may be performed by an activation state manager 1030 as described with reference to FIG. 10.

At 1815, the method may include monitoring, in accordance with the determination, at least a portion of control signaling that includes the multi-cell scheduling message. The operations of 1815 may be performed in accordance with examples as disclosed herein. In some examples, aspects of the operations of 1815 may be performed by a multi-cell scheduling monitoring manager 1035 as described with reference to FIG. 10.

At 1820, the method may include determining to monitor for the multi-cell scheduling message based on at least one serving cell of the set of multiple serving cells of the serving cell group being in an activated state at the UE. The operations of 1820 may be performed in accordance with examples as disclosed herein. In some examples, aspects of the operations of 1820 may be performed by a multi-cell scheduling monitoring manager 1035 as described with reference to FIG. 10.

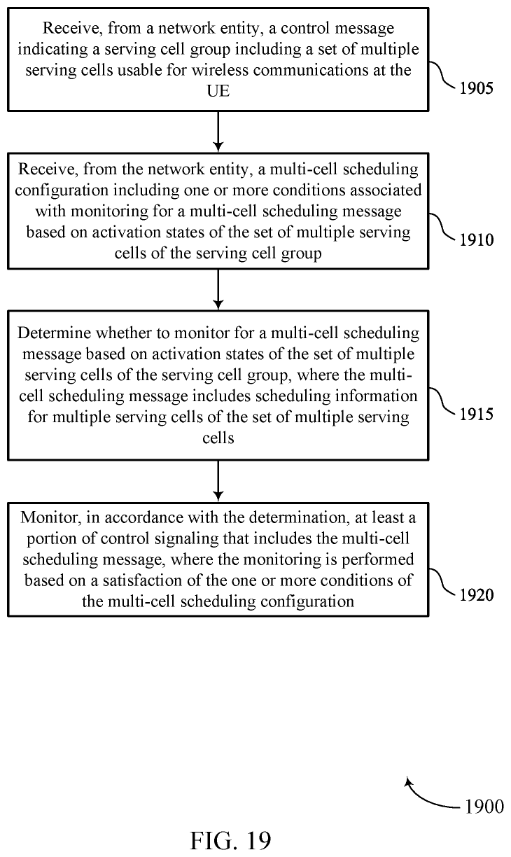

FIG. 19 illustrates a flowchart illustrating a method 1900 that supports techniques for multi-cell scheduling in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving, from a network entity, a control message indicating a serving cell group including a set of multiple serving cells usable for wireless communications at the UE. The operations of 1905 may be performed in accordance with examples as disclosed herein. In some examples, aspects of the operations of 1905 may be performed by a control message receiving manager 1025 as described with reference to FIG. 10.

At 1910, the method may include receiving, from the network entity, a multi-cell scheduling configuration including one or more conditions associated with monitoring for a multi-cell scheduling message based on activation states of the set of multiple serving cells of the serving cell group. The operations of 1910 may be performed in accordance with examples as disclosed herein. In some examples, aspects of the operations of 1910 may be performed by a multi-cell scheduling configuration manager 1040 as described with reference to FIG. 10.

At 1915, the method may include determining whether to monitor for a multi-cell scheduling message based on activation states of the set of multiple serving cells of the serving cell group, where the multi-cell scheduling message includes scheduling information for multiple serving cells of the set of multiple serving cells. The operations of 1915 may be performed in accordance with examples as disclosed herein. In some examples, aspects of the operations of 1915 may be performed by an activation state manager 1030 as described with reference to FIG. 10.

At 1920, the method may include monitoring, in accordance with the determination, at least a portion of control signaling that includes the multi-cell scheduling message, where the monitoring is performed based on a satisfaction of the one or more conditions of the multi-cell scheduling configuration. The operations of 1920 may be performed in accordance with examples as disclosed herein. In some examples, aspects of the operations of 1920 may be performed by a multi-cell scheduling monitoring manager 1035 as described with reference to FIG. 10.

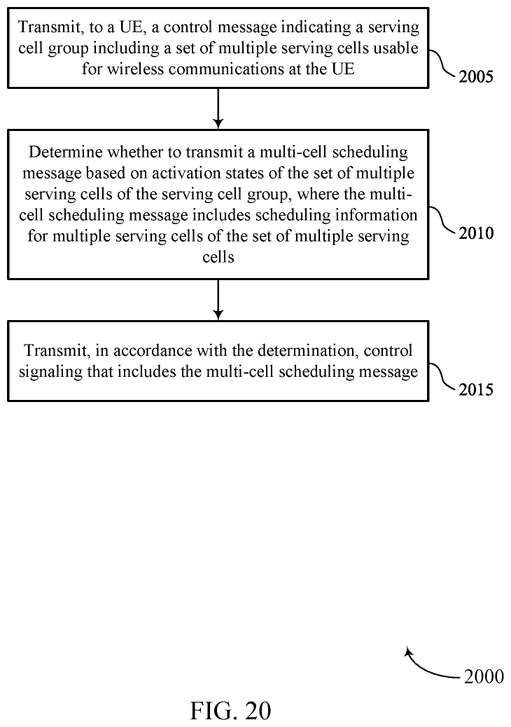

FIG. 20 illustrates a flowchart illustrating a method 2000 that supports techniques for multi-cell scheduling in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a UE, a control message indicating a serving cell group including a set of multiple serving cells usable for wireless communications at the UE. The operations of 2005 may be performed in accordance with examples as disclosed herein. In some examples, aspects of the operations of 2005 may be performed by a control message transmitting manager 1425 as described with reference to FIG. 14.

At 2010, the method may include determining whether to transmit a multi-cell scheduling message based on activation states of the set of multiple serving cells of the serving cell group, where the multi-cell scheduling message includes scheduling information for multiple serving cells of the set of multiple serving cells. The operations of 2010 may be performed in accordance with examples as disclosed herein. In some examples, aspects of the operations of 2010 may be performed by a multi-cell scheduling transmitting manager 1430 as described with reference to FIG. 14.

At 2015, the method may include transmitting, in accordance with the determination, control signaling that includes the multi-cell scheduling message. The operations of 2015 may be performed in accordance with examples as disclosed herein. In some examples, aspects of the operations of 2015 may be performed by a status report message transmitting manager 1435 as described with reference to FIG. 14.

The following provides an overview of aspects of the present disclosure:

Aspect 1: A method for wireless communication at a UE, comprising: receiving, from a network entity, a control message indicating a serving cell group comprising a plurality of serving cells usable for wireless communications at the UE; determining whether to monitor for a multi-cell scheduling message based at least in part on activation states of the plurality of serving cells of the serving cell group, wherein the multi-cell scheduling message includes scheduling information for multiple serving cells of the plurality of serving cells; and monitoring, in accordance with the determination, at least a portion of control signaling that includes the multi-cell scheduling message.

Aspect 2: The method of aspect 1, wherein determining whether to monitor for the multi-cell scheduling message further comprises: determining to monitor for the multi-cell scheduling message based at least in part on each of the plurality of serving cells of the serving cell group being in an active operational state at the UE.

Aspect 3: The method of any of aspects 1 through 2, wherein determining whether to monitor for the multi-cell scheduling message further comprises: determining to monitor for the multi-cell scheduling message based at least in part on at least one serving cell of the plurality of serving cells of the serving cell group being in an active operational state at the UE.

Aspect 4: The method of any of aspects 1 through 3, further comprising: determining a plurality of activation states associated with the plurality of serving cells of the serving cell group; and determining a control message format associated with the multi-cell scheduling message based at least in part on the plurality of activation states, wherein monitoring at least the portion of the control signaling comprises monitoring for the control message format associated with the multi-cell scheduling message.

Aspect 5: The method of any of aspects 1 through 4, further comprising: receiving, from the network entity, a multi-cell scheduling configuration comprising one or more conditions associated with monitoring for the multi-cell scheduling message based at least in part on activation states of the plurality of serving cells of the serving cell group, wherein the monitoring is performed based at least in part on a satisfaction of the one or more conditions of the multi-cell scheduling configuration.

Aspect 6: The method of any of aspects 1 through 5, further comprising: receiving, from the network entity, a message indicating a deactivation of at least one serving cell of the serving cell group; and deactivating each of the plurality of serving cells of the serving cell group based at least in part on the message.

Aspect 7: The method of any of aspects 1 through 6, wherein the monitoring is performed throughout a first time interval, the method further comprising: refraining from monitoring for an additional multi-cell scheduling message for the serving cell group throughout a second time interval subsequent to the first time interval; and monitoring the control signaling throughout the second time interval for a self-scheduling message associated with one or more serving cells of the serving cell group, a cross-carrier scheduling message associated with one or more serving cells of the serving cell group, or both.

Aspect 8: The method of any of aspects 1 through 7, further comprising: restarting a plurality of timers associated with activation states of the plurality of serving cells of the serving cell group based at least in part on receiving the multi-cell scheduling message.

Aspect 9: The method of any of aspects 1 through 8, wherein the plurality of serving cells of the serving cell group comprise at least a first serving cell and a second serving cell, the method further comprising: receiving, via the multi-cell scheduling message, a first indication of a first quantity of RBs allocated for communications with the UE via the first serving cell, and a second indication of a second quantity of RBs allocated for communications with the UE via the second serving cell; restarting a first timer associated with a first activation state of the first serving cell based on the first quantity of RBs satisfying a threshold quantity; and refraining from restarting a second timer associated with a second activation state of the second serving cell based at least in part on the second quantity of RBs failing to satisfy the threshold quantity.

Aspect 10: The method of aspect 9, further comprising: identifying an expiration of the second timer associated with the second serving cell based at least in part on refraining from restarting the second timer; and deactivating the second serving cell based at least in part on the expiration of the second timer.

Aspect 11: The method of any of aspects 9 through 10, further comprising: deactivating the first serving cell of the serving cell group based at least in part on deactivating the second serving cell.

Aspect 12: The method of any of aspects 1 through 11, further comprising: receiving, from the network entity, a multi-cell scheduling configuration comprising one or more conditions for restarting activation timers associated with the plurality of serving cells of the serving cell group; and restarting one or more activation timers associated with one or more serving cells of the serving cell group based at least in part on a satisfaction of the one or more conditions of the multi-cell scheduling configuration.

Aspect 13: The method of any of aspects 1 through 12, wherein the plurality of serving cells of the serving cell group comprise at least a first serving cell and a second serving cell, and wherein the first serving cell is in a deactivated operational state at the UE, the method further comprising: receiving, via the multi-cell scheduling message, an indication of a set of RBs allocated for communications with the UE via the first serving cell; and transmitting a feedback message to the network entity based at least in part on the first serving cell being in the deactivated operational state and based at least in part on the set of RBs being allocated for communications via the first serving cell.

Aspect 14: The method of any of aspects 1 through 13, wherein the plurality of serving cells of the serving cell group comprise at least a first serving cell and a second serving cell, and wherein the first serving cell is in a deactivated operational state at the UE, the method further comprising: receiving, via the multi-cell scheduling message, an indication of a set of RBs allocated for communications with the UE via the first serving cell; and transmitting a message to the network entity indicating a mis-match associated with operational states of the first serving cell at the UE and the network entity, the message comprising a cell identifier associated with the first serving cell and an indication of the deactivated operational state of the first serving cell at the UE.

Aspect 15: The method of aspect 14, wherein the message comprises a UCI message, a RACH message, a MAC-CE message, an RRC message, or any combination thereof.

Aspect 16: The method of any of aspects 1 through 15, wherein the plurality of serving cells of the serving cell group comprise at least a first serving cell and a second serving cell, and wherein the first serving cell is in a deactivated operational state at the UE, the method further comprising: receiving, via the multi-cell scheduling message, an indication of a set of RBs allocated for communications with the UE via the first serving cell; and activating the first serving cell from the deactivated operational state to an activated operational state based at least in part on the first serving cell being in the deactivated operational state and based at least in part on the set of RBs being allocated for communications via the first serving cell.

Aspect 17: The method of aspect 16, further comprising: transmitting a status report message to the network entity based at least in part on activating the first serving cell; and communicating with the network entity via the first serving cell based at least in part on the status report message.

Aspect 18: A method for wireless communication at a network entity, comprising: transmitting, to a UE, a control message indicating a serving cell group comprising a plurality of serving cells usable for wireless communications at the UE; determining whether to transmit a multi-cell scheduling message based at least in part on activation states of the plurality of serving cells of the serving cell group, wherein the multi-cell scheduling message includes scheduling information for multiple serving cells of the plurality of serving cells; and transmitting, in accordance with the determination, control signaling that includes the multi-cell scheduling message.

Aspect 19: The method of aspect 18, wherein determining whether to transmit the multi-cell scheduling message further comprises: determining to transmit for the multi-cell scheduling message based at least in part on each of the plurality of serving cells of the serving cell group being in an active operational state at the UE.

Aspect 20: The method of any of aspects 18 through 19, wherein determining whether to transmit the multi-cell scheduling message further comprises: determining to transmit for the multi-cell scheduling message based at least in part on at least one serving cell of the plurality of serving cells of the serving cell group being in an active operational state at the UE.

Aspect 21: The method of any of aspects 18 through 20, further comprising: determining a plurality of activation states associated with the plurality of serving cells of the serving cell group; and determining a control message format associated with the multi-cell scheduling message based at least in part on the plurality of activation states, wherein the multi-cell scheduling message is associated with the control message format.

Aspect 22: The method of any of aspects 18 through 21, further comprising: transmitting, to the UE, a multi-cell scheduling configuration comprising one or more conditions associated with the multi-cell scheduling message based at least in part on activation states of the plurality of serving cells of the serving cell group, wherein transmitting the multi-cell scheduling message is based at least in part on a satisfaction of the one or more conditions of the multi-cell scheduling configuration.

Aspect 23: The method of any of aspects 18 through 22, further comprising: transmitting, to the UE, a message indicating a deactivation of at least one serving cell of the serving cell group; and deactivating each of the plurality of serving cells of the serving cell group based at least in part on the message.

Aspect 24: The method of any of aspects 18 through 23, wherein the multi-cell scheduling message is transmitted within a first time interval, the method further comprising: refraining from transmitting for an additional multi-cell scheduling message for the serving cell group throughout a second time interval subsequent to the first time interval; and transmitting the control signaling throughout the second time interval for a self-scheduling message associated with one or more serving cells of the serving cell group, a cross-carrier scheduling message associated with one or more serving cells of the serving cell group, or both.

Aspect 25: The method of any of aspects 18 through 24, further comprising: restarting a plurality of timers associated with activation states of the plurality of serving cells of the serving cell group based at least in part on transmitting the multi-cell scheduling message.

Aspect 26: The method of any of aspects 18 through 25, wherein the plurality of serving cells of the serving cell group comprise at least a first serving cell and a second serving cell, the method further comprising: transmitting, via the multi-cell scheduling message, a first indication of a first quantity of RBs allocated for communications with the UE via the first serving cell, and a second indication of a second quantity of RBs allocated for communications with the UE via the second serving cell; restarting a first timer associated with a first activation state of the first serving cell based at least in part on the first quantity of RBs satisfying a threshold quantity; and refraining from restarting a second timer associated with a second activation state of the second serving cell based at least in part on the second quantity of RBs failing to satisfy the threshold quantity.

Aspect 27: The method of aspect 26, further comprising: identifying an expiration of the second timer associated with the second serving cell based at least in part on refraining from restarting the second timer; and deactivating the second serving cell based at least in part on the expiration of the second timer.

Aspect 28: The method of aspect 27, further comprising: deactivating the first serving cell of the serving cell group based at least in part on deactivating the second serving cell.

Aspect 29: The method of any of aspects 18 through 28, further comprising: transmitting, to the UE, a multi-cell scheduling configuration comprising one or more conditions for restarting activation timers associated with the plurality of serving cells of the serving cell group; and restarting one or more activation timers associated with one or more serving cells of the serving cell group based at least in part on a satisfaction of the one or more conditions of the multi-cell scheduling configuration.

Aspect 30: The method of any of aspects 18 through 29, wherein the plurality of serving cells of the serving cell group comprise at least a first serving cell and a second serving cell, and wherein the first serving cell is in a deactivated operational state at the UE, the method further comprising: transmitting, via the multi-cell scheduling message, an indication of a set of RBs allocated for communications with the UE via the first serving cell; and receiving a feedback message from the UE based at least in part on the first serving cell being in the deactivated operational state at the UE and based at least in part on the set of RBs being allocated for communications via the first serving cell.

Aspect 31: The method of any of aspects 18 through 30, wherein the plurality of serving cells of the serving cell group comprise at least a first serving cell and a second serving cell, and wherein the first serving cell is in an activated operational state at the UE, the method further comprising: transmitting, via the multi-cell scheduling message, an indication of a set of RBs allocated for communications with the UE via the first serving cell; and receiving a message from the UE indicating a mis-match associated with operational states of the first serving cell at the UE and the network entity, the message comprising a cell identifier associated with the first serving cell and an indication that the first serving cell is in a deactivated operational state at the UE.

Aspect 32: The method of aspect 31, wherein the message comprises a UCI message, a RACH message, a MAC-CE message, an RRC message, or any combination thereof.

Aspect 33: The method of any of aspects 18 through 32, further comprising: receiving a status report message from the UE based at least in part on the multi-cell scheduling message; and communicating with the UE via a serving cell of the serving cell group based at least in part on the status report message.

Aspect 34: An apparatus comprising a processor; memory coupled with the processor; and instructions stored in the memory and executable by the processor to cause the apparatus to perform a method of any of aspects 1 through 17.

Aspect 35: An apparatus comprising at least one means for performing a method of any of aspects 1 through 17.

Aspect 36: A non-transitory computer-readable medium storing code the code comprising instructions executable by a processor to perform a method of any of aspects 1 through 17.

Aspect 37: An apparatus comprising a processor; memory coupled with the processor; and instructions stored in the memory and executable by the processor to cause the apparatus to perform a method of any of aspects 18 through 33.

Aspect 38: An apparatus comprising at least one means for performing a method of any of aspects 18 through 33.

Aspect 39: A non-transitory computer-readable medium storing code the code comprising instructions executable by a processor to perform a method of any of aspects 18 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a processor;
memory coupled with the processor; and
instructions stored in the memory and executable by the processor to cause the apparatus to:
receive, from a network entity, a control message indicating a serving cell group comprising a plurality of serving cells usable for wireless communications at a user equipment (UE);
determine whether to monitor for a multi-cell scheduling message based at least in part on activation states of the plurality of serving cells of the serving cell group, wherein the multi-cell scheduling message includes scheduling information for multiple serving cells of the plurality of serving cells; and
monitor, in accordance with the determination, at least a portion of control signaling that includes the multi-cell scheduling message.

2. The apparatus of claim 1, wherein the instructions to determine whether to monitor for the multi-cell scheduling message are further executable by the processor to cause the apparatus to:
determine to monitor for the multi-cell scheduling message based at least in part on each of the plurality of serving cells of the serving cell group being in an activated state at the UE.

3. The apparatus of claim 1, wherein the instructions to determine whether to monitor for the multi-cell scheduling message are further executable by the processor to cause the apparatus to:
determine to monitor for the multi-cell scheduling message based at least in part on at least one serving cell of the plurality of serving cells of the serving cell group being in an activated state at the UE.

4. The apparatus of claim 1, wherein the instructions are further executable by the processor to cause the apparatus to:
determine a plurality of activation states associated with the plurality of serving cells of the serving cell group; and
determine a control message format associated with the multi-cell scheduling message based at least in part on the plurality of activation states, wherein monitoring at least the portion of the control signaling comprises monitoring for the control message format associated with the multi-cell scheduling message.

5. The apparatus of claim 1, wherein the instructions are further executable by the processor to cause the apparatus to:
receive, from the network entity, a multi-cell scheduling configuration comprising one or more conditions associated with monitoring for the multi-cell scheduling message based at least in part on activation states of the plurality of serving cells of the serving cell group, wherein the monitoring is performed based at least in part on a satisfaction of the one or more conditions of the multi-cell scheduling configuration.

6. The apparatus of claim 1, wherein the instructions are further executable by the processor to cause the apparatus to:
receive, from the network entity, a message indicating a deactivation of at least one serving cell of the serving cell group; and
deactivate each of the plurality of serving cells of the serving cell group based at least in part on the message.

7. The apparatus of claim 1, wherein the monitoring is performed throughout a first time interval, wherein the instructions are further executable by the processor to cause the apparatus to:
refrain from monitoring for an additional multi-cell scheduling message for the serving cell group throughout a second time interval subsequent to the first time interval; and
monitor the control signaling throughout the second time interval for a self-scheduling message associated with one or more serving cells of the serving cell group, a cross-carrier scheduling message associated with one or more serving cells of the serving cell group, or both.

8. The apparatus of claim 1, wherein the instructions are further executable by the processor to cause the apparatus to:
restart a plurality of timers associated with activation states of the plurality of serving cells of the serving cell group based at least in part on receiving the multi-cell scheduling message.

9. The apparatus of claim 1, wherein the plurality of serving cells of the serving cell group comprise at least a first serving cell and a second serving cell, wherein the instructions are further executable by the processor to cause the apparatus to:
receive, via the multi-cell scheduling message, a first indication of a first quantity of resource blocks allocated for communications with the UE via the first serving cell, and a second indication of a second quantity of resource blocks allocated for communications with the UE via the second serving cell;
restart a first timer associated with a first activation state of the first serving cell based at least in part on the first quantity of resource blocks satisfying a threshold quantity; and
refrain from restarting a second timer associated with a second activation state of the second serving cell based at least in part on the second quantity of resource blocks failing to satisfy the threshold quantity.

10. The apparatus of claim 9, wherein the instructions are further executable by the processor to cause the apparatus to:
identify an expiration of the second timer associated with the second serving cell based at least in part on refraining from restarting the second timer; and
deactivate the second serving cell based at least in part on the expiration of the second timer.

11. The apparatus of claim 9, wherein the instructions are further executable by the processor to cause the apparatus to:
deactivate the first serving cell of the serving cell group based at least in part on deactivating the second serving cell.

12. The apparatus of claim 1, wherein the instructions are further executable by the processor to cause the apparatus to:
receive, from the network entity, a multi-cell scheduling configuration comprising one or more conditions for restarting activation timers associated with the plurality of serving cells of the serving cell group; and
restart one or more activation timers associated with one or more serving cells of the serving cell group based at least in part on a satisfaction of the one or more conditions of the multi-cell scheduling configuration.

13. The apparatus of claim 1, wherein the plurality of serving cells of the serving cell group comprise at least a first serving cell and a second serving cell, and wherein the first serving cell is in a deactivated state at the UE, wherein the instructions are further executable by the processor to cause the apparatus to:
receive, via the multi-cell scheduling message, an indication of a set of resource blocks allocated for communications with the UE via the first serving cell; and
transmit a feedback message to the network entity based at least in part on the first serving cell being in the deactivated state and based at least in part on the set of resource blocks being allocated for communications via the first serving cell.

14. The apparatus of claim 1, wherein the plurality of serving cells of the serving cell group comprise at least a first serving cell and a second serving cell, and wherein the first serving cell is in a deactivated state at the UE, wherein the instructions are further executable by the processor to cause the apparatus to:
receive, via the multi-cell scheduling message, an indication of a set of resource blocks allocated for communications with the UE via the first serving cell; and
transmit a message to the network entity indicating a mis-match associated with activation states of the first serving cell at the UE and the network entity, the message comprising a cell identifier associated with the first serving cell and an indication of the deactivated state of the first serving cell at the UE.

15. The apparatus of claim 14, wherein the message comprises an uplink control information message, a random access channel message, a medium access control-control element message, a radio resource control message, or any combination thereof.

16. The apparatus of claim 1, wherein the plurality of serving cells of the serving cell group comprise at least a first serving cell and a second serving cell, and wherein the first serving cell is in a deactivated state at the UE, wherein the instructions are further executable by the processor to cause the apparatus to:
receive, via the multi-cell scheduling message, an indication of a set of resource blocks allocated for communications with the UE via the first serving cell; and
activate the first serving cell from the deactivated state to an activated state based at least in part on the first serving cell being in the deactivated state and based at least in part on the set of resource blocks being allocated for communications via the first serving cell.

17. The apparatus of claim 16, wherein the instructions are further executable by the processor to cause the apparatus to:
transmit a status report message to the network entity based at least in part on activating the first serving cell; and
communicate with the network entity via the first serving cell based at least in part on the status report message.

18. An apparatus, comprising:
a processor;
memory coupled with the processor; and
instructions stored in the memory and executable by the processor to cause the apparatus to:
transmit, to a user equipment (UE), a control message indicating a serving cell group comprising a plurality of serving cells usable for wireless communications at the UE;
determine whether to transmit a multi-cell scheduling message based at least in part on activation states of the plurality of serving cells of the serving cell group, wherein the multi-cell scheduling message includes scheduling information for multiple serving cells of the plurality of serving cells; and
transmit, in accordance with the determination, control signaling that includes the multi-cell scheduling message.

19. The apparatus of claim 18, wherein the instructions to determine whether to transmit the multi-cell scheduling message are further executable by the processor to cause the apparatus to:
determine to transmit for the multi-cell scheduling message based at least in part on each of the plurality of serving cells of the serving cell group being in an activated state at the UE.

20. The apparatus of claim 18, wherein the instructions to determine whether to transmit the multi-cell scheduling message are further executable by the processor to cause the apparatus to:
determine to transmit for the multi-cell scheduling message based at least in part on at least one serving cell of the plurality of serving cells of the serving cell group being in an activated state at the UE.

21. The apparatus of claim 18, wherein the instructions are further executable by the processor to cause the apparatus to:
determine a plurality of activation states associated with the plurality of serving cells of the serving cell group; and
determine a control message format associated with the multi-cell scheduling message based at least in part on the plurality of activation states, wherein the multi-cell scheduling message is associated with the control message format.

22. The apparatus of claim 18, wherein the instructions are further executable by the processor to cause the apparatus to:
transmit, to the UE, a multi-cell scheduling configuration comprising one or more conditions associated with the multi-cell scheduling message based at least in part on activation states of the plurality of serving cells of the serving cell group, wherein transmitting the multi-cell scheduling message is based at least in part on a satisfaction of the one or more conditions of the multi-cell scheduling configuration.

23. The apparatus of claim 18, wherein the instructions are further executable by the processor to cause the apparatus to:
transmit, to the UE, a message indicating a deactivation of at least one serving cell of the serving cell group; and
deactivate each of the plurality of serving cells of the serving cell group based at least in part on the message.

24. The apparatus of claim 18, wherein the multi-cell scheduling message is transmitted within a first time interval, wherein the instructions are further executable by the processor to cause the apparatus to:
refrain from transmitting for an additional multi-cell scheduling message for the serving cell group throughout a second time interval subsequent to the first time interval; and
transmit the control signaling throughout the second time interval for a self-scheduling message associated with one or more serving cells of the serving cell group, a cross-carrier scheduling message associated with one or more serving cells of the serving cell group, or both.

25. The apparatus of claim 18, wherein the instructions are further executable by the processor to cause the apparatus to:
restart a plurality of timers associated with activation states of the plurality of serving cells of the serving cell group based at least in part on transmitting the multi-cell scheduling message.

26. The apparatus of claim 18, wherein the plurality of serving cells of the serving cell group comprise at least a first serving cell and a second serving cell, wherein the instructions are further executable by the processor to cause the apparatus to:
transmit, via the multi-cell scheduling message, a first indication of a first quantity of resource blocks allocated for communications with the UE via the first serving cell, and a second indication of a second quantity of resource blocks allocated for communications with the UE via the second serving cell;
restart a first timer associated with a first activation state of the first serving cell based at least in part on the first quantity of resource blocks satisfying a threshold quantity; and
refrain from restarting a second timer associated with a second activation state of the second serving cell based at least in part on the second quantity of resource blocks failing to satisfy the threshold quantity.

27. The apparatus of claim 26, wherein the instructions are further executable by the processor to cause the apparatus to:
identify an expiration of the second timer associated with the second serving cell based at least in part on refraining from restarting the second timer; and
deactivate the second serving cell based at least in part on the expiration of the second timer.

28. The apparatus of claim 18, wherein the instructions are further executable by the processor to cause the apparatus to:
transmit, to the UE, a multi-cell scheduling configuration comprising one or more conditions for restarting activation timers associated with the plurality of serving cells of the serving cell group; and
restart one or more activation timers associated with one or more serving cells of the serving cell group based at least in part on a satisfaction of the one or more conditions of the multi-cell scheduling configuration.

29. A method for wireless communication at a user equipment (UE), comprising:
receiving, from a network entity, a control message indicating a serving cell group comprising a plurality of serving cells usable for wireless communications at the UE;
determining whether to monitor for a multi-cell scheduling message based at least in part on activation states of the plurality of serving cells of the serving cell group, wherein the multi-cell scheduling message includes scheduling information for multiple serving cells of the plurality of serving cells; and
monitoring, in accordance with the determination, at least a portion of control signaling that includes the multi-cell scheduling message.

30. A method for wireless communication at a network entity, comprising:
transmitting, to a user equipment (UE), a control message indicating a serving cell group comprising a plurality of serving cells usable for wireless communications at the UE;
determining whether to transmit a multi-cell scheduling message based at least in part on activation states of the plurality of serving cells of the serving cell group, wherein the multi-cell scheduling message includes scheduling information for multiple serving cells of the plurality of serving cells; and
transmitting, in accordance with the determination, control signaling that includes the multi-cell scheduling message.
